(19) United States
(12) Patent Application Publication
(10) Pub. No.: US 2026/0269890 A1
(43) Pub. Date: Sep. 10, 2026

(54) FACILITATING SUB-BAND PRECODING FOR NON-COHERENT CODEBOOK BASED PUSCH

(71) Applicant: Nokia Technologies Oy, Espoo (FI)

(72) Inventors: Sami-Jukka HAKOLA, Oulu (FI); Frederick VOOK, Schaumburg (IL)

(21) Appl. No.: 19/075,392

(22) Filed: Mar. 10, 2025

(51) Int. Cl. H04B 7/0456; H04B 7/06; H04L 5/00

(52) U.S. Cl. CPC H04B 7/0456; H04B 7/0626; H04L 5/0044; H04L 5/0098

(57) ABSTRACT

An apparatus configured to: receive, from a network node, at least one channel state information reference signal; estimate a downlink channel based, at least partially, on the at least one channel state information reference signal; estimate an uplink channel based, at least partially, on the estimated downlink channel; determine a rank indicator and at least one precoder matrix based, at least partially, on the estimated uplink channel; and transmit, to the network node using the plurality of sub-bands, at least one uplink transmission based, at least partially, on the determined rank indicator and the at least one determined precoder matrix.

### TECHNICAL FIELD

The example and non-limiting embodiments relate generally to uplink (UL) multiple input multiple output (MIMO) operation and, more particularly, to sub-band based precoding for PUSCH transmission with multiple transmission antenna.

### BACKGROUND

It is known, in sub-band based precoding, for each sub-band, the precoder matrix selected for that sub-band is selected from a set of precoder matrices, where that set is the same for all sub-bands used for PUSCH transmission.

### SUMMARY

The following summary is merely intended to be illustrative. The summary is not intended to limit the scope of the claims.

In accordance with one aspect, an apparatus comprising: at least one processor; and at least one memory storing instructions that, when executed with the at least one processor, cause the apparatus at least to: receive, from a network node, an indication of a precoder matrix, for a respective sub-band of a plurality of sub-bands configured for uplink transmission, wherein the precoder matrix is comprised in a set of precoder matrices that is configured for the respective sub-band; and transmit, to the network node using the plurality of sub-bands, at least one uplink transmission based, at least partially, on the indication of the precoder matrix for the respective sub-band.

In accordance with one aspect, a method comprising: receiving, with a user equipment from a network node, an indication of a precoder matrix, for a respective sub-band of a plurality of sub-bands configured for uplink transmission, wherein the precoder matrix is comprised in a set of precoder matrices that is configured for the respective sub-band; and transmitting, to the network node using the plurality of sub-bands, at least one uplink transmission based, at least partially, on the indication of the precoder matrix for the respective sub-band.

In accordance with one aspect, an apparatus comprising means for causing the apparatus to perform at least: receiving, from a network node, an indication of a precoder matrix, for a respective sub-band of a plurality of sub-bands configured for uplink transmission, wherein the precoder matrix is comprised in a set of precoder matrices that is configured for the respective sub-band; and transmitting, to the network node using the plurality of sub-bands, at least one uplink transmission based, at least partially, on the indication of the precoder matrix for the respective sub-band.

In accordance with one aspect, a computer-readable medium comprising instructions stored thereon for performing at least the following: causing receiving, with a user equipment from a network node, of an indication of a precoder matrix, for a respective sub-band of a plurality of sub-bands configured for uplink transmission, wherein the precoder matrix is comprised in a set of precoder matrices that is configured for the respective sub-band; and causing transmitting, to the network node using the plurality of sub-bands, of at least one uplink transmission based, at least partially, on the indication of the precoder matrix for the respective sub-band.

In accordance with one aspect, an apparatus comprising: at least one processor; and at least one memory storing instructions that, when executed with the at least one processor, cause the apparatus at least to: determine, for a respective sub-band of a plurality of sub-bands configured for uplink transmission with a user equipment, a precoder matrix from a set of precoder matrices that is configured for the respective sub-band; and transmit, to the user equipment, an indication of the determined precoder matrix for the respective sub-band.

In accordance with one aspect, a method comprising: determining, with a network node for a respective sub-band of a plurality of sub-bands configured for uplink transmission with a user equipment, a precoder matrix from a set of precoder matrices that is configured for the respective sub-band; and transmitting, to the user equipment, an indication of the determined precoder matrix for the respective sub-band.

In accordance with one aspect, an apparatus comprising means for causing the apparatus to perform at least: determining, for a respective sub-band of a plurality of sub-bands configured for uplink transmission with a user equipment, a precoder matrix from a set of precoder matrices that is configured for the respective sub-band; and transmitting, to the user equipment, an indication of the determined precoder matrix for the respective sub-band.

In accordance with one aspect, a computer-readable medium comprising instructions stored thereon for performing at least the following: causing determining, with a network node for a respective sub-band of a plurality of sub-bands configured for uplink transmission with a user equipment, of a precoder matrix from a set of precoder matrices that is configured for the respective sub-band; and causing transmitting, to the user equipment, of an indication of the determined precoder matrix for the respective sub-band.

In accordance with one aspect, an apparatus comprising: at least one processor; and at least one memory storing instructions that, when executed with the at least one processor, cause the apparatus at least to: receive, from a network node, an indication of an allowable set of precoder matrices for a respective sub-band of a plurality of sub-bands configured for uplink transmission; determine, for the respective sub-band of the plurality of sub-bands, a precoder matrix from the allowable set of precoder matrices; and transmit, to the network node using the plurality of sub-bands, at least one uplink transmission based, at least partially, on the determined precoder matrix.

In accordance with one aspect, a method comprising: receiving, with a user equipment from a network node, an indication of an allowable set of precoder matrices for a respective sub-band of a plurality of sub-bands configured for uplink transmission; determining, for the respective sub-band of the plurality of sub-bands, a precoder matrix from the allowable set of precoder matrices; and transmitting, to the network node using the plurality of sub-bands, at least one uplink transmission based, at least partially, on the determined precoder matrix.

In accordance with one aspect, an apparatus comprising means for causing the apparatus to perform at least: receiving, from a network node, an indication of an allowable set of precoder matrices for a respective sub-band of a plurality of sub-bands configured for uplink transmission; determining, for the respective sub-band of the plurality of sub-bands, a precoder matrix from the allowable set of precoder matrices; and transmitting, to the network node using the plurality of sub-bands, at least one uplink transmission based, at least partially, on the determined precoder matrix.

In accordance with one aspect, a computer-readable medium comprising instructions stored thereon for performing at least the following: causing receiving, with a user equipment from a network node, of an indication of an allowable set of precoder matrices for a respective sub-band of a plurality of sub-bands configured for uplink transmission; determining, for the respective sub-band of the plurality of sub-bands, a precoder matrix from the allowable set of precoder matrices; and causing transmitting, to the network node using the plurality of sub-bands, of at least one uplink transmission based, at least partially, on the determined precoder matrix.

In accordance with one aspect, an apparatus comprising: at least one processor; and at least one memory storing instructions that, when executed with the at least one processor, cause the apparatus at least to: determine, for a respective sub-band of a plurality of sub-bands configured for uplink transmission with a user equipment, an allowable set of precoder matrices; and transmit, to the user equipment, an indication of the allowable set of precoder matrices for the respective sub-band.

In accordance with one aspect, a method comprising: determining, with a network node for a respective sub-band of a plurality of sub-bands configured for uplink transmission with a user equipment, an allowable set of precoder matrices; and transmitting, to the user equipment, an indication of the allowable set of precoder matrices for the respective sub-band.

In accordance with one aspect, an apparatus comprising means for causing the apparatus to perform at least: determining, for a respective sub-band of a plurality of sub-bands configured for uplink transmission with a user equipment, an allowable set of precoder matrices; and transmitting, to the user equipment, an indication of the allowable set of precoder matrices for the respective sub-band.

In accordance with one aspect, a computer-readable medium comprising instructions stored thereon for performing at least the following: determining, with a network node for a respective sub-band of a plurality of sub-bands configured for uplink transmission with a user equipment, of an allowable set of precoder matrices; and causing transmitting, to the user equipment, of an indication of the allowable set of precoder matrices for the respective sub-band.

In accordance with one aspect, an apparatus comprising: at least one processor; and at least one memory storing instructions that, when executed with the at least one processor, cause the apparatus at least to: receive, from a network node, an indication of an ordered set of sub-band precoder matrices, for transmitting at least one uplink transmission using a plurality of sub-bands, wherein the ordered set of sub-band precoder matrices is comprised in a plurality of configured ordered sets of sub-band precoder matrices; and transmit, to the network node, the at least one uplink transmission based, at least partially, on the indication of the ordered set of sub-band precoder matrices.

In accordance with one aspect, a method comprising: receiving, with a user equipment from a network node, an indication of an ordered set of sub-band precoder matrices, for transmitting at least one uplink transmission using a plurality of sub-bands, wherein the ordered set of sub-band precoder matrices is comprised in a plurality of configured ordered sets of sub-band precoder matrices; and transmitting, to the network node, the at least one uplink transmission based, at least partially, on the indication of the ordered set of sub-band precoder matrices.

In accordance with one aspect, an apparatus comprising means for causing the apparatus to perform at least: receiving, from a network node, an indication of an ordered set of sub-band precoder matrices, for transmitting at least one uplink transmission using a plurality of sub-bands, wherein the ordered set of sub-band precoder matrices is comprised in a plurality of configured ordered sets of sub-band precoder matrices; and transmitting, to the network node, the at least one uplink transmission based, at least partially, on the indication of the ordered set of sub-band precoder matrices.

In accordance with one aspect, a computer-readable medium comprising instructions stored thereon for performing at least the following: causing receiving, with a user equipment from a network node, of an indication of an ordered set of sub-band precoder matrices, for transmitting at least one uplink transmission using a plurality of sub-bands, wherein the ordered set of sub-band precoder matrices is comprised in a plurality of configured ordered sets of sub-band precoder matrices; and causing transmitting, to the network node, of the at least one uplink transmission based, at least partially, on the indication of the ordered set of sub-band precoder matrices.

In accordance with one aspect, an apparatus comprising: at least one processor; and at least one memory storing instructions that, when executed with the at least one processor, cause the apparatus at least to: determine, for a plurality of sub-bands configured for uplink transmission with a user equipment, an ordered set of sub-band precoder matrices from a plurality of configured ordered sets of sub-band precoder matrices; and transmit, to the user equipment, an indication of the ordered set of sub-band precoder matrices.

In accordance with one aspect, a method comprising: determining, with a network node for a plurality of sub-bands configured for uplink transmission with a user equipment, an ordered set of sub-band precoder matrices from a plurality of configured ordered sets of sub-band precoder matrices; and transmitting, to the user equipment, an indication of the ordered set of sub-band precoder matrices.

In accordance with one aspect, an apparatus comprising means for causing the apparatus to perform at least: determining, for a plurality of sub-bands configured for uplink transmission with a user equipment, an ordered set of sub-band precoder matrices from a plurality of configured ordered sets of sub-band precoder matrices; and transmitting, to the user equipment, an indication of the ordered set of sub-band precoder matrices.

In accordance with one aspect, a computer-readable medium comprising instructions stored thereon for performing at least the following: determining, with a network node for a plurality of sub-bands configured for uplink transmission with a user equipment, an ordered set of sub-band precoder matrices from a plurality of configured ordered sets of sub-band precoder matrices; and causing transmitting, to the user equipment, of an indication of the ordered set of sub-band precoder matrices.

In accordance with one aspect, an apparatus comprising: at least one processor; and at least one memory storing instructions that, when executed with the at least one processor, cause the apparatus at least to: receive, from a network node, an indication of two or more ordered sets of sub-band precoder matrices for transmitting at least one uplink transmission using a plurality of sub-bands; determine, for the plurality of sub-bands, an ordered set of sub-band precoder matrices from the two or more ordered sets of sub-band precoder matrices; and transmit, to the network node, the at least one uplink transmission based, at least partially, on the determined ordered set of sub-band precoder matrices.

In accordance with one aspect, a method comprising: receiving, with a user equipment from a network node, an indication of two or more ordered sets of sub-band precoder matrices for transmitting at least one uplink transmission using a plurality of sub-bands; determining, for the plurality of sub-bands, an ordered set of sub-band precoder matrices from the two or more ordered sets of sub-band precoder matrices; and transmitting, to the network node, the at least one uplink transmission based, at least partially, on the determined ordered set of sub-band precoder matrices.

In accordance with one aspect, an apparatus comprising means for causing the apparatus to perform at least: receiving, from a network node, an indication of two or more ordered sets of sub-band precoder matrices for transmitting at least one uplink transmission using a plurality of sub-bands; determining, for the plurality of sub-bands, an ordered set of sub-band precoder matrices from the two or more ordered sets of sub-band precoder matrices; and transmitting, to the network node, the at least one uplink transmission based, at least partially, on the determined ordered set of sub-band precoder matrices.

In accordance with one aspect, a computer-readable medium comprising instructions stored thereon for performing at least the following: causing receiving, with a user equipment from a network node, of an indication of two or more ordered sets of sub-band precoder matrices for transmitting at least one uplink transmission using a plurality of sub-bands; determining, for the plurality of sub-bands, an ordered set of sub-band precoder matrices from the two or more ordered sets of sub-band precoder matrices; and causing transmitting, to the network node, of the at least one uplink transmission based, at least partially, on the determined ordered set of sub-band precoder matrices.

In accordance with one aspect, an apparatus comprising: at least one processor; and at least one memory storing instructions that, when executed with the at least one processor, cause the apparatus at least to: determine, for a plurality of sub-bands configured for uplink transmission with a user equipment, two or more ordered sets of sub-band precoder matrices; and transmit, to the user equipment, an indication of the two or more ordered sets of sub-band precoder matrices.

In accordance with one aspect, a method comprising: determining, with a network node for a plurality of sub-bands configured for uplink transmission with a user equipment, two or more ordered sets of sub-band precoder matrices; and transmitting, to the user equipment, an indication of the two or more ordered sets of sub-band precoder matrices.

In accordance with one aspect, an apparatus comprising means for causing the apparatus to perform at least: determining, for a plurality of sub-bands configured for uplink transmission with a user equipment, two or more ordered sets of sub-band precoder matrices; and transmitting, to the user equipment, an indication of the two or more ordered sets of sub-band precoder matrices.

In accordance with one aspect, a computer-readable medium comprising instructions stored thereon for performing at least the following: determining, with a network node for a plurality of sub-bands configured for uplink transmission with a user equipment, two or more ordered sets of sub-band precoder matrices; and causing transmitting, to the user equipment, of an indication of the two or more ordered sets of sub-band precoder matrices.

In accordance with one aspect, an apparatus comprising: at least one processor; and at least one memory storing instructions that, when executed with the at least one processor, cause the apparatus at least to: receive, from a network node, at least one channel state information reference signal; estimate a downlink channel based, at least partially, on the at least one channel state information reference signal; estimate an uplink channel based, at least partially, on the estimated downlink channel; determine a rank indicator and at least one precoder matrix based, at least partially, on the estimated uplink channel, wherein the at least one precoder matrix comprises at least one of: a precoder matrix comprised in one of: a set of precoder matrices configured for a sub-band of a plurality of sub-bands configured for uplink transmission, or a set of precoder matrices indicated, by the network node, for the sub-band of the plurality of sub-bands, or an ordered set of sub-band precoder matrices comprised in one of: a plurality of configured ordered sets of sub-band precoder matrices, or a plurality of ordered sets of sub-band precoder matrices indicated by the network node; and transmit, to the network node using the plurality of sub-bands, at least one uplink transmission based, at least partially, on the determined rank indicator and the at least one determined precoder matrix.

In accordance with one aspect, a method comprising: receiving, with a user equipment from a network node, at least one channel state information reference signal; estimating a downlink channel based, at least partially, on the at least one channel state information reference signal; estimating an uplink channel based, at least partially, on the estimated downlink channel; determining a rank indicator and at least one precoder matrix based, at least partially, on the estimated uplink channel, wherein the at least one precoder matrix comprises at least one of: a precoder matrix comprised in one of: a set of precoder matrices configured for a sub-band of a plurality of sub-bands configured for uplink transmission, or a set of precoder matrices indicated, by the network node, for the sub-band of the plurality of sub-bands, or an ordered set of sub-band precoder matrices comprised in one of: a plurality of configured ordered sets of sub-band precoder matrices, or a plurality of ordered sets of sub-band precoder matrices indicated by the network node; and transmitting, to the network node using the plurality of sub-bands, at least one uplink transmission based, at least partially, on the determined rank indicator and the at least one determined precoder matrix.

In accordance with one aspect, an apparatus comprising means for causing the apparatus to perform at least: receiving, from a network node, at least one channel state information reference signal; estimating a downlink channel based, at least partially, on the at least one channel state information reference signal; estimating an uplink channel based, at least partially, on the estimated downlink channel; determining a rank indicator and at least one precoder matrix based, at least partially, on the estimated uplink channel, wherein the at least one precoder matrix comprises at least one of: a precoder matrix comprised in one of: a set of precoder matrices configured for a sub-band of a plurality of sub-bands configured for uplink transmission, or a set of precoder matrices indicated, by the network node, for the sub-band of the plurality of sub-bands, or an ordered set of sub-band precoder matrices comprised in one of: a plurality of configured ordered sets of sub-band precoder matrices, or a plurality of ordered sets of sub-band precoder matrices indicated by the network node; and transmitting, to the network node using the plurality of sub-bands, at least one uplink transmission based, at least partially, on the determined rank indicator and the at least one determined precoder matrix.

In accordance with one aspect, a computer-readable medium comprising instructions stored thereon for performing at least the following: causing receiving, with a user equipment from a network node, of at least one channel state information reference signal; estimating a downlink channel based, at least partially, on the at least one channel state information reference signal; estimating an uplink channel based, at least partially, on the estimated downlink channel; determining a rank indicator and at least one precoder matrix based, at least partially, on the estimated uplink channel, wherein the at least one precoder matrix comprises at least one of: a precoder matrix comprised in one of: a set of precoder matrices configured for a sub-band of a plurality of sub-bands configured for uplink transmission, or a set of precoder matrices indicated, by the network node, for the sub-band of the plurality of sub-bands, or an ordered set of sub-band precoder matrices comprised in one of: a plurality of configured ordered sets of sub-band precoder matrices, or a plurality of ordered sets of sub-band precoder matrices indicated by the network node; and causing transmitting, to the network node using the plurality of sub-bands, of at least one uplink transmission based, at least partially, on the determined rank indicator and the at least one determined precoder matrix.

According to some aspects, there is provided the subject matter of the independent claims. Some further aspects are defined in the dependent claims.

### BRIEF DESCRIPTION OF THE DRAWINGS

The foregoing aspects and other features are explained in the following description, taken in connection with the accompanying drawings, wherein:

FIG. 1 is a block diagram of one possible and non-limiting example system in which the example embodiments may be practiced;

FIG. 2 is a diagram illustrating features as described herein;

FIG. 3 is a flowchart illustrating steps as described herein;

FIGS. 4, 5, 6, 7, and 8 are each diagrams illustrating features as described herein; and

FIGS. 9, 10, 11, 12, 13, 14, 15, 16, 17, and 18 are each flowcharts illustrating steps as described herein.

### DETAILED DESCRIPTION OF EMBODIMENTS

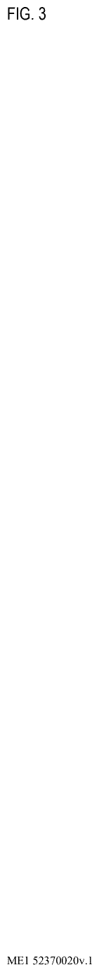

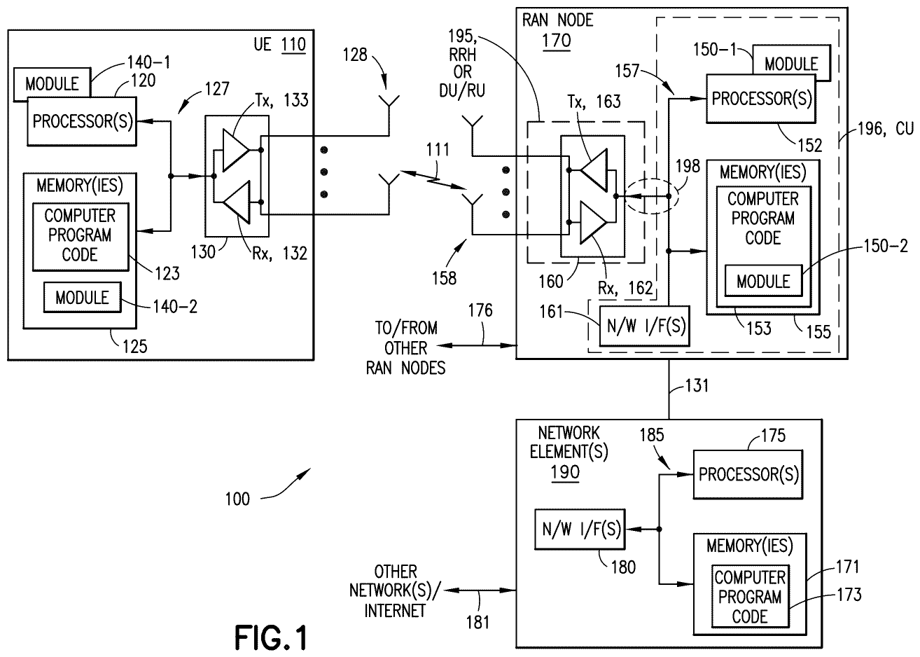

Turning to FIG. 1, this figure shows a block diagram of one possible and non-limiting example in which the examples may be practiced. A user equipment (UE) 110, radio access network (RAN) node 170, and network element(s) 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. A “circuit” may include dedicated hardware or hardware in association with software executable thereon. The one or more transceivers 130 are connected to one or more antennas 128. The one or more memories 125 have instructions stored there on, such as computer readable code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer readable code 123 and is executed by the one or more processors 120. For instance, the one or more memories 125 and the computer readable code 123 may be configured to, with the one or more processors 120, cause the user equipment 110 to perform one or more of the operations as described herein. The UE 110 communicates with RAN node 170 via a wireless link 111.

The RAN node 170 in this example is a base station that provides access by wireless devices such as the UE 110 to the wireless network 100. The RAN node 170 may be, for example, a base station for 5G, also called New Radio (NR). In 5G, the RAN node 170 may be a NG-RAN node, which is defined as either a gNB or a ng-eNB. A gNB is a node providing NR user plane and control plane protocol terminations towards the UE, and connected via the NG interface to a 5GC (such as, for example, the network element(s) 190). The ng-eNB is a node providing E-UTRA user plane and control plane protocol terminations towards the UE, and connected via the NG interface to the 5GC. The NG-RAN node may include multiple gNBs, which may also include a central unit (CU) (gNB-CU) 196 and distributed unit(s) (DUs) (gNB-DUs), of which DU 195 is shown. Note that the DU may include or be coupled to and control a radio unit (RU). The gNB-CU is a logical node hosting RRC, SDAP and PDCP protocols of the gNB or RRC and PDCP protocols of the en-gNB that controls the operation of one or more gNB-DUs. The gNB-CU terminates the F1 interface connected with the gNB-DU. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU is a logical node hosting RLC, MAC and PHY layers of the gNB or en-gNB, and its operation is partly controlled by gNB-CU. One gNB-CU supports one or multiple cells. One cell is supported by only one gNB-DU. The gNB-DU terminates the F1 interface 198 connected with the gNB-CU. Note that the DU 195 is considered to include the transceiver 160, e.g., as part of a RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station, access point, access node, or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 store instructions such as computer readable code 153. The CU 196 may include the processor(s) 152, memories 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer readable code 153 and is executed by the one or more processors 152. For instance, the one or more memories 155 and the computer readable code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU, and the one or more buses 157 could be implemented in part as, for example, fiber optic cable or other suitable network connection to connect the other elements (e.g., a central unit (CU), gNB-CU) of the RAN node 170 to the RRH/DU 195. Reference 198 also indicates those suitable network link(s).

It is noted that description herein indicates that “cells” perform functions, but it should be clear that equipment which forms the cell will perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include access and mobility management function(s) (AMF(s)) and/or user plane functions (UPF(s)) and/or session management function(s) (SMF(s)). Such core network functionality for LTE may include MME (Mobility Management Entity)/SGW (Serving Gateway) functionality. These are merely illustrative functions that may be supported by the network element(s) 190, and note that both 5G and LTE functions might be supported. The RAN node 170 is coupled via a link 131 to a network element 190. The link 131 may be implemented as, e.g., an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer readable code 173. The one or more memories 171 and the computer readable code 173 are configured to, with the one or more processors 175, cause the network element 190 to perform one or more operations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. For example, a network may be deployed in a tele cloud, with virtualized network functions (VNF) running on, for example, data center servers. For example, network core functions and/or radio access network(s) (e.g. CloudRAN, O-RAN, edge cloud) may be virtualized. Note that the virtualized entities that result from the network virtualization are still implemented, at some level, using hardware such as processors 152 or 175 and memories 155 and 171, and also such virtualized entities create technical effects.

It may also be noted that operations of example embodiments of the present disclosure may be carried out by a plurality of cooperating devices (e.g. cRAN).

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, and other functions as described herein.

In general, the various example embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

Having thus introduced one suitable but non-limiting technical context for the practice of the example embodiments of the present disclosure, example embodiments will now be described with greater specificity.

Features as described herein may generally relate to 5G and 6G physical layer design. More specifically, features as described herein may generally relate to enhancements to non-coherent codebook (CB) based UL MIMO operation with respect to sub-band based precoding.

Currently, 3GPP 5G defines two UL MIMO transmission schemes: non-codebook-based (NCB) transmission and codebook-based (CB) transmission. In non-codebook based transmission, the user equipment (UE) measures downlink DL channel state information (CSI) reference signal(s) (CSI-RS) to generate its own precoding weights for the physical uplink shared channel (PUSCH). These precoding weights are not constrained to a codebook standardized by the 3GPP. By contrast, in codebook-based transmission, the UE transmits the PUSCH using precoding weights that have been selected from a codebook standardized by 3GPP. These standardized codebooks are carefully designed to satisfy the specific antenna configurations.

In codebook-based UL multiple input multiple output (MIMO) transmission, three different coherency assumptions among UE's TX antenna ports are supported:
Non-coherent, where antenna ports cannot be coherently combined. For rank one transmission, a layer is transmitted only from one antenna port. For higher rank transmission, each layer is transmitted out of a different antenna.
Partial coherent, where the antenna ports are divided into two or more antenna groups, and the antenna ports in an antenna group are coherent but antenna ports belonging to different antenna groups are not coherent. A layer is transmitted only from the antennas of one of the antenna groups.
Full coherent, where all antenna ports can be coherently combined. The layers are transmitted coherently across all antenna ports.

Typically, 5G smartphone-type UEs that have been deployed in the field support only non-coherent codebook based PUSCH transmission.

Up to 5 G Rel-19 only wideband based precoding is supported for the codebook based PUSCH. To enhance UL MIMO performance, sub-band based precoding is being considered as a possible topic for 5G Rel-20 . With all currently-deployed 5G smartphone-type UEs having a non-coherent architecture, the use of sub-band based precoding by UEs with a non-coherent architecture is of particular interest.

In the closed-loop UL precoding methodology, the UE sends (typically non-precoded) SRS on the UL, and the gNB determines the precoder for the UE to use on the PUSCH from a codebook of precoders. The gNB sends a transmit precoder matrix index (TPMI) to the UE to indicate the precoder for the UE to use on the PUSCH.

In the present disclosure, the terms precoder matrix, precoder, and precoder vector may be used interchangeably to refer to precoding weights or antenna selections used for transmitting PUSCH. The term “precoder matrix” may be considered a general term that includes “precoder vector”. In the present disclosure, the terms “codebook” and “set of precoders” may be used interchangeably.

The topic of frequency selective precoding (e.g. sub-band precoding) versus wideband precoding for the uplink has been discussed n RAN1. One of the key concerns is that the TPMI overhead for sub-band precoding might be significantly larger than the overhead required to indicate a wideband TPMI.

In sub-band based precoding, the precoder selected for each sub-band is selected from a set of allowable precoders, where that set of allowable precoders is assumed to be the same for each sub-band.

In sub-band based precoding, different precoding would be applied to different sub-bands in the frequency domain. Non-coherent rank 1 codebooks (CBs) are selection-type precoders based on which the UE transmits a layer out of only one antenna at a time. In the rank 1 case, if the precoder selection is per-sub-band, then each sub-band is transmitted with the TX antenna indicated by the precoder, which means the TX antenna is changing across the band. If the TX antenna is being changed across the band, then one antenna might have a lot more sub-bands that it transmits over compared to another antenna(s). That may lead to a situation where one antenna cannot reach the targeted received power per sub-band at the gNB, for example if we assume a constant transmit power spectral density (PSD) on every sub-band and TX antenna, which may cause degraded performance. Also, if we assume an equal split of the TX power across, for example, two TX antennas, then the PSD for sub-bands on the TX antennas that are only occasionally selected might be too high.

A technical effect of example embodiments of the present disclosure may be to manage and/or control the PSD per sub-band on each antenna, as well as the overall TX power on each antenna, for any given selection of TX antennas on the different sub-bands across the allocated signal bandwidth.

In an example embodiment, uplink precoder design options for sub-band based precoding for uplink transmission may be implemented. In an example embodiment, a constrained set of TPMI possibilities may be associated with each sub-band. In an example embodiment, a constrained set of precoder patterns may be associated with sub-band precoding. In an example embodiment, the codebook implemented at a UE may comprise one or more constrained sets of TPMI possibilities per sub-band, and/or may comprise one or more precoder patterns. In an example embodiment, a constrained set of TPMI possibilities per sub-band may be adaptively signaled to the UE. In an example embodiment, a constrained set of precoder patterns may be adaptively signaled to the UE. In an example embodiment, the network may determine which precoder, from a sub-band specific set of precoders, is to be used by the UE. In an example embodiment, the UE may determine which precoder, from a sub-band specific set of precoders, is to be used by the UE. In an example embodiment, the network may determine which precoder pattern, from a set of precoder patterns, is to be used by the UE. In an example embodiment, the UE may determine which precoder pattern, from a set of precoder patterns, is to be used by the UE.

A technical effect of example embodiments of the present disclosure may be to enable the UE to optimize use of antennas, from the transmission power point of view, across all the sub-bands within the total allocation bandwidth for the transmission.

In an example embodiment, the network may define multiple possible precoders per sub-band from which the UE can choose a precoder per sub-band. A constrained set of TPMI possibilities may potentially be different on each sub-band. Alternatively, a same constrained set of TPMI possibilities may be defined for each sub-band. The constrained set may be determined to ensure favorable PSD or PSD characteristics. A separate TPMI on each sub-band may be selected from the allowable set on each sub-band. For N sub-bands, N TPMIs may be signaled, one per sub-band, but the set of allowable precoders on each sub-band may be designed for favorable TX power, or TX power characteristics, across the antennas across the band.

In an example embodiment, a codebook of precoder entries may be defined, where each entry may specify which antennas are transmitting on each sub-bands (e.g. the number on each sub-band corresponds to the rank of the transmission). The NW may define a set of these entries per sub-band, and the UE may select the best one in each sub-band, for example based on transmission power, or transmission power characteristics.

The set may be designed so that the TX power, or TX power characteristics, of each entry are favorable. One way to make the TX power, or TX power characteristics, “favorable” would be to design the allowable precoders on each sub-band so that no matter which precoders are selected for the sub-bands, the overall usage of the TX antennas across the band are equal (or approximately equal). Additionally or alternatively, Tx power (or Tx power characteristics) may be favorable if PSD is controlled during PUSCH transmission across the band comprising the sub-bands. Additionally or alternatively, Tx power (characteristics) may be favorable if PUSCH is received by the gNB with sufficient power and with minimal or no interference.

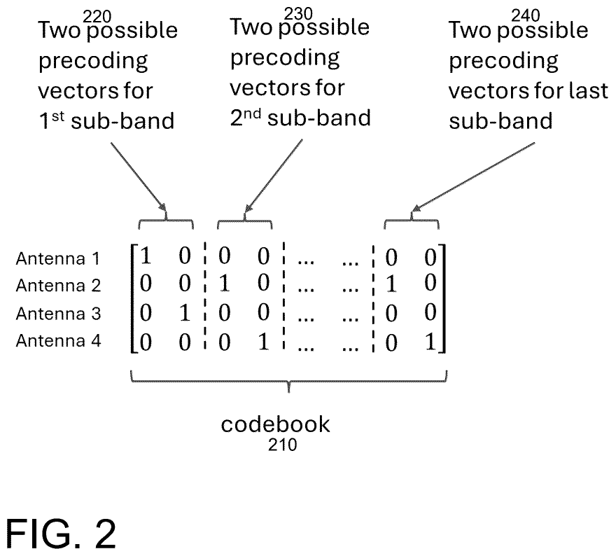

Referring now to FIG. 2, illustrated is an example for rank 1 transmission in which there are N sub-bands and for each sub-band, there are two possible precoding vectors defined in a codebook (210), from which one is selected for transmission per sub-band. In the example of FIG. 2, the UE is configured with four antennas. For the 1st sub-band, two possible precoding vectors (220) are defined in the codebook (210): antenna 1 or antenna 3 may be used for transmitting the 1^{st} sub-band carrying PUSCH. For the 2^{nd} sub-band, two possible precoding vectors (230) are defined in the codebook (210): antenna 2 or antenna 4 may be used for transmitting the 2nd sub-band carrying PUSCH. For the N-1th or last sub-band, two possible precoding vectors (240) are defined in the codebook (210): antenna 2 or antenna 4 may be used for transmitting the last sub-band carrying PUSCH.

In this example embodiment, the set of allowable precoders may be sub-band dependent. For example, each sub-band may have a set of allowable precoders that is different from the set of allowable precoders for a different sub-band. The set of allowable precoders may be designed so as to enable favorable TX power, or TX power characteristic(s).

The gNB may also set the same precoding vectors for a sub-band if the network wants UE to use certain antenna for the certain sub-band. In other words, the set of precoding vectors determined for a sub-band may comprise multiple copies of the same precoding vector, or may only comprise a single precoding vector, such that the UE is required to use a particular antenna for the sub-band.

It should be noted that there may be additional scaling of the precoder vector that may be required, e.g., for setting the desired TX power. For example, the actual precoder matrix may be multiplied by a scalar factor to achieve, for example, the desired TX power. The scalar factor may not change the transmit characteristics (e.g., angular direction) of the precoder.

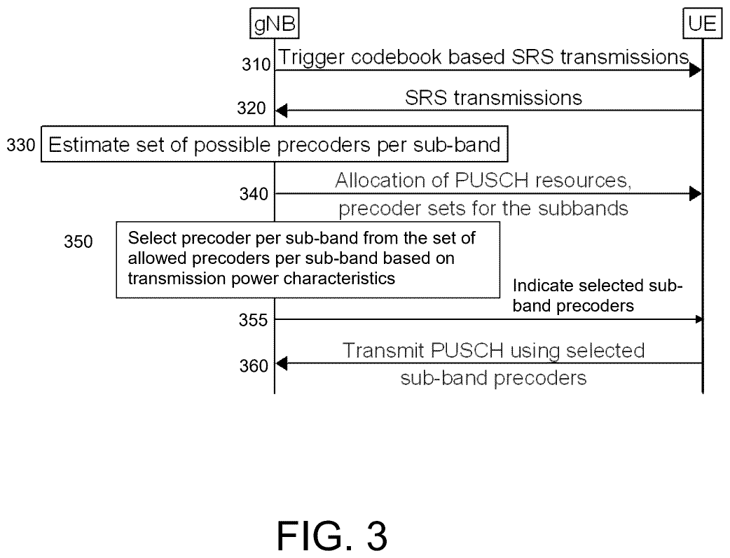

Referring now to FIG. 3, illustrated is an example of signaling between a gNB and a UE according to an example embodiment of the present disclosure. At 310, the gNB may trigger codebook based sounding reference signal (SRS) transmissions by the UE. At 320, the UE may transmit SRS transmission(s) to the gNB. At 330, the gNB may estimate the set of possible precoders per sub-band based, at least partially, on the received SRS. For example the gNB may estimate or obtain channel conditions, conditions of the antenna of the UE, power at which transmission from each antenna of the UE is received at the gNB, etc. This information may be estimated or obtained on a sub-band basis. At 340, the gNB may transmit, to the UE, an allocation of PUSCH resources. Together with the PUSCH resource allocation, or separately (e.g. via dedicated signaling, DCI, MAC CE, etc.), the gNB may transmit, to the UE, an indication of precoder sets that are allowed to be used for each UL sub-band. For example, the gNB may transmit multiple TPMI for each sub-band in order to indicate multiple precoders that may be used for that sub-band (e.g. a set of TPMIs that comprises a subset of a total number of TPMIs/precoders included in a codebook, or indices into a codebook). At 350, the gNB may select a precoder per sub-band from the set of allowed precoders per sub-band and then, at 355, signal to the UE an index per sub-band to indicate the selected precoder per sub-band. This gNB selection may be performed based on at least the SRS and, at least partially, on one or more transmission power, or transmission power characteristics (e.g. total transmit power on each antenna), associated with each antenna, each precoder per sub-band, and/or per sub-band. Optionally, the selection may be made by the UE based on measured DL CSI-RS. At 360, the UE may transmit, to the gNB, PUSCH using the selected sub-band precoders.

Alternatively, the UE may be (pre)configured with a set of precoders per subband, such that, at 340, the UE may receive an indication of a precoder within a configured set, rather than an indication of the sets of subbands. This indication of a precoder may be received with the allocation of PUSCH resources, or separately (e.g. via dedicated signaling, DCI, MAC CE, etc.). The indication of a precoder for a sub-band, within the set configured for the sub-band, may comprise a TPMI. In this scenario, the UE may not need to select a precoder per sub-band as at 350, but rather may apply the indicated precoders on the respective subbands for PUSCH transmission.

In another example embodiment, the network may create or select a precoder pattern that is designed according to certain constraints regarding TX power (characteristics) and use of antennas. K TPMI patterns may be defined in the codebook, where each pattern may specify the precoder to be used on each sub-band. One of the total K TPMI patterns may be selected for use.

In the present disclosure, the terms precoder pattern, TPMI pattern, precoder sequence, ordered set of precoders or precoder vectors or precoder matrixes, and matrix of precoders may be used interchangeably to refer to a plurality of precoders that are used for a plurality of sub-bands in a defined or repeating manner, as further illustrated in the examples of the present disclosure.

In an example embodiment, multiple sets of precoder vectors/matrices may be defined, where each set (or pattern) of precoder vectors/matrices may contain the precoders that may be used across all the sub-bands used to transmit PUSCH. For example, if there are N sub-bands, there may be up to N precoders in each set. For each set of precoders, the transmit antennas may be selected across the sub-bands in a way that has the technical effect of creating a balanced use of the TX antennas.

In an example embodiment, the gNB may measure the UL SRS transmitted by the UE and pick the best set of precoders for the UE to use across all the sub-bands. If there are defined in the codebook K sets of precoders (each set containing N precoders for N sub-bands), then only log 2(K) bits may be needed to indicate to the UE which set of precoders to use across all the sub-bands.

For a given transmission rank, for the precoders in each set of precoders, each precoder may specify which antenna(s) will transmit on each sub-band. To create a balanced use of the TX antennas across the band, the number of sub-bands in which one antenna is transmitting should be identical to, or close to or substantially identical to, the number of sub-bands in which another antenna is transmitting.

Some example TPMI patterns for rank 1 transmission are described in the following. However, these examples are not limiting; any TPMI pattern that is defined with the view of balancing use of UE antennas, or balancing PSD or balancing overall transmit power per UE antenna, for PUSCH transmission may be used.

In the following examples, the precoder selecting the Xth antenna may be a precoder with all zeros except for a one in the Xth entry, where we are neglecting, for the sake of simplicity, any additional scaling of the precoder vector that may be required (e.g., for setting the desired TX power).

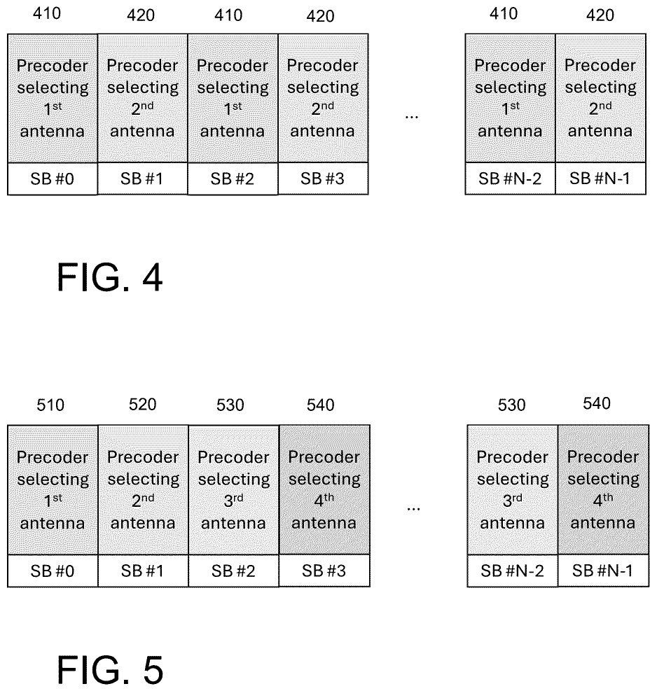

FIG. 4 illustrates, in an exemplary manner, a TPMI pattern in the case of two TX antennas and a transmission rank of one. In this TPMI pattern, the precoder selecting the 1st antenna (410) is used in every second sub-band (or every other sub-band), and similarly for the 2nd antenna (420). In other words, the example TPMI pattern comprises a repeating pattern of selection of the 1^{st} antenna (410) followed by selection of the 2^{nd} antenna (420) across the sub-bands used for transmitting PUSCH.

FIG. 5 illustrates, in an exemplary manner, a TPMI pattern in the case of four TX antennas and a transmission rank of one. In this TPMI pattern, the precoder selecting the 1st antenna (510) is used in every fourth sub-band (e.g. every fourth sub-band is precoded with the precoder that selects the first antenna), and similarly for 2^{nd} (520), 3rd (530) and 4th antenna (540). In other words, the example TPMI pattern comprises a repeating pattern of selection of the 1^{st} antenna (510) followed by selection of the 2^{nd} antenna (520) followed by selection of the 3^{rd} antenna (530) followed by selection of the 4^{th} antenna (540) across the sub-bands used for transmitting PUSCH. Alternatively, the example TPMI pattern comprises repetition of a set of antenna in a defined order.

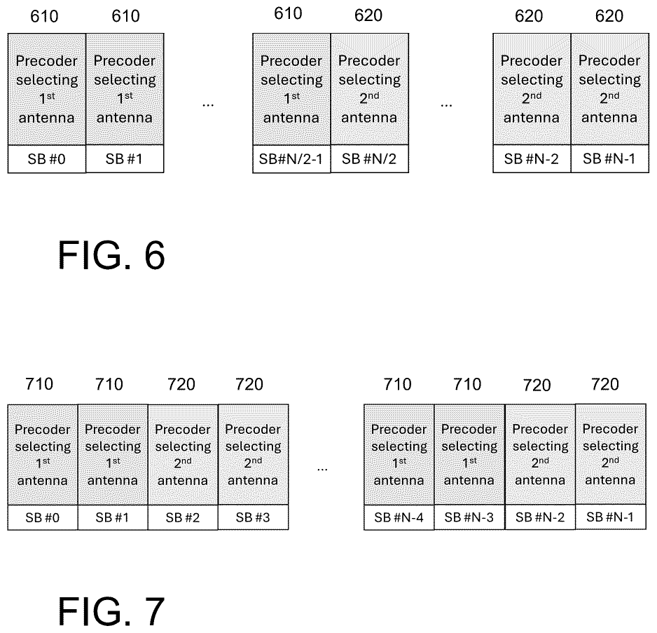

FIG. 6 illustrates, in an exemplary manner, a TPMI pattern in the case of two TX antennas and a transmission rank of one. In this TPMI pattern, sub-bands in the first half of the transmission bandwidth are transmitted using the 1st antenna (610) and sub-bands in the latter half of the transmission bandwidth are transmitted using the 2nd antenna (620).

FIG. 7 illustrates, in an exemplary manner, a TPMI pattern in the case of two TX antennas and a transmission rank of one. In this TPMI pattern, one TX antenna transmits in M (e.g. M=2) consecutive sub-bands. This pattern may repeat. In the example of FIG. 7, the 1st antenna (710) may transmit PUSCH in M=2 consecutive sub-bands, and then the 2^{nd} antenna (720) may transmit PUSCH in M=2 consecutive sub-bands, across the sub-bands used for transmitting PUSCH.

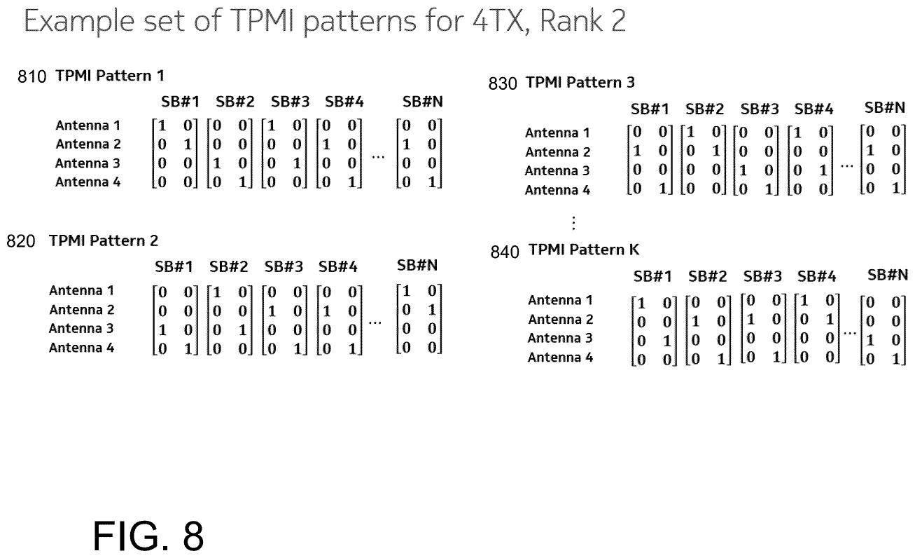

FIG. 8 illustrates, in an exemplary manner, TPMI patterns in the case of 4TX and rank 2 transmission. In these examples, there are K patterns in the set of precoders, or codebook of precoders. Each pattern specifies a 4×2 precoder matrix (4TX, 2 layers) that may be used on each of the N sub-bands (SB #1 . . . SB #N).

In TPMI pattern 1 (810), antennas 1 and 2 are selected to transmit the two layers of sub-band 1. Antennas 3 and 4 are selected to transmit the two layers of sub-band 2. Antennas 1 and 3 are selected to transmit the two layers of sub-band 3. Antennas 2 and 4 are selected to transmit the two layers of sub-band 4. Antennas 2 and 4 are selected to transmit the two layers of sub-band N.

In TPMI pattern 2 (820), antennas 3 and 4 are selected to transmit the two layers of sub-band 1. Antennas 1 and 3 are selected to transmit the two layers of sub-band 2. Antennas 2 and 4 are selected to transmit the two layers of sub-band 3. Antennas 2 and 4 are selected to transmit the two layers of sub-band 4. Antennas 1 and 2 are selected to transmit the two layers of sub-band N.

In TPMI pattern 3 (830), antennas 2 and 4 are selected to transmit the two layers of sub-band 1. Antennas 1 and 2 are selected to transmit the two layers of sub-band 2. Antennas 3 and 4 are selected to transmit the two layers of sub-band 3. Antennas 1 and 3 are selected to transmit the two layers of sub-band 4. Antennas 2 and 4 are selected to transmit the two layers of sub-band N.

In TPMI pattern 4 (840), antennas 1 and 3 are selected to transmit the two layers of sub-band 1. Antennas 2 and 4 are selected to transmit the two layers of sub-band 2. Antennas 2 and 4 are selected to transmit the two layers of sub-band 3. Antennas 1 and 2 are selected to transmit the two layers of sub-band 4. Antennas 3 and 4 are selected to transmit the two layers of sub-band N.

The design of the TPMI patterns may have the technical effect that the usage of any given TX antenna across the signal bandwidth is roughly the same as the other TX antennas. In this example embodiment, the gNB is selecting the one TPMI pattern out of the K total TPMI patterns, and only log 2(K) bits are needed to signal the selected TPMI pattern.

In an example embodiment, may be defined that when transmitting with two TX antennas, there may be a requirement that the least occupied antenna (in terms of the number sub-bands that the antenna is transmitting on) shall be used at least a predefined portion of the sub-bands (e.g. 40 or 45%).

In an example embodiment, the ability to put all the transmit power into one TX antenna may be supported so as to support closed-loop wideband TX antenna switching. In another example embodiment, the ability to have one or more (but not all) antennas turned off may be supported.

For each transmission rank, there may be defined in the codebook a set of TPMI patterns having a number K of TPMI patterns, and each TPMI pattern may specify the precoder vector/matrix (dimensioned Ntx by number of layers) to be used on each of the N sub-bands.

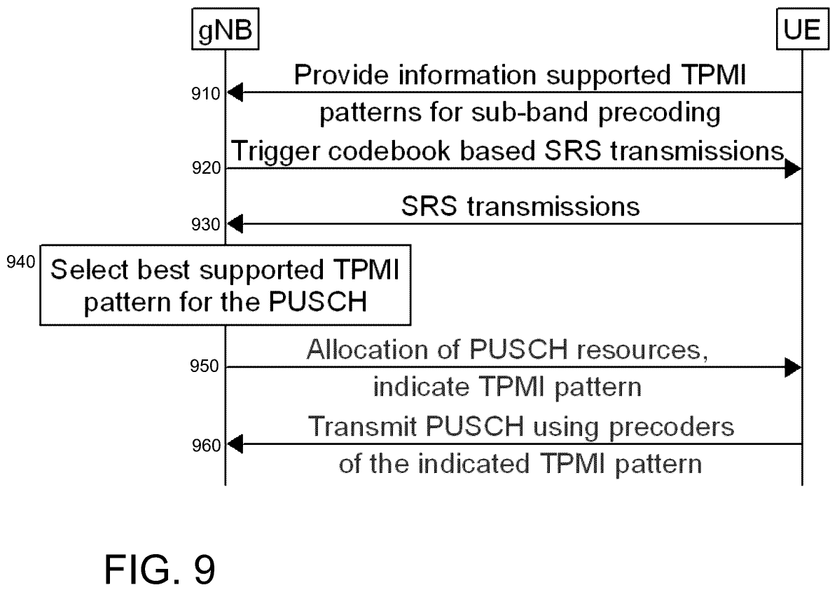

Referring now to FIG. 9, illustrated is an example of signaling between a gNB and a UE according to an example embodiment of the present disclosure. At 910, the UE may transmit, to the gNB, information regarding supported TPMI patterns for sub-band precoding. At 920, the gNB may transmit, to the UE, a trigger for codebook based SRS transmission. At 930, the UE may transmit non-precoded SRS on the uplink from its N TX antennas. At 940, the gNB may select a preferred rank and a preferred TPMI pattern from the set of K TPMI patterns for the selected rank. This selection may be based, at least partially, on the received SRS. At 950, the gNB may indicate one of the selected TPMI patterns to the UE when scheduling uplink transmission. The indication of one or more TPMI patterns may comprise, for example, an index identifying one of a plurality of TPMI patterns (e.g. ordered sets of sub-band precoders) defined in a codebook (e.g. ordered set index). Optionally, the allocation of PUSCH resources may be indicated separately from the indicated TPMI patterns (e.g. via dedicated signaling, DCI, MAC CE, etc.). At 960, the UE may transmit PUSCH to the gNB using precoders of the indicated TPMI pattern.

In an example embodiment, the UE may be configured with a plurality of TPMI patterns. Optionally, each TPMI pattern, or a subset of the plurality of TPMI patterns, may be associated with a transmission rank.

In an example embodiment, the codebook, or set of possible precoders, may be specified or (pre)configured. For example, the set of possible TPMI precoders or precoder patterns may be specified in a fixed manner (i.e. the gNB may select the best TPMI/precoder based on SRS). In this case, the UE may send SRS, and the gNB may signal to the UE the TPMI per sub-band, or the TPMI pattern. Then the UE may transmit PUSCH with the indicated precoder (i.e. indicated for each sub-band, or indicated via a pattern). The codebook may be designed to have the technical effect of ensuring favorable or good TX power, or TX power characteristics.

Alternatively, the UE may select the best TPMI/precoder based on DL-CSI-RS. The UE may measure DL CSI-RS and determine the precoder to use, which may belong to the signaled set for a sub-band. In other words, SRS may not be used, by the NW, for determining the best TPMI. This may be similar to the case above where the CB may be adaptively signaled to the UE; the use of the specified codebook may mean that the UE does not need to solve the problem of determining UL precoders that are both good for the channel and good for TX power characteristics: the specified codebooks in the specification may have already been designed to solve that problem ahead of time.

In an alternative example embodiment, the set of possible precoders may be adaptively signaled to the UE. The gNB may measure the UL SRS from the UE, and adaptively determine what the set of precoders per sub-band, or the precoder pattern, should be based at least on the measured UL channel. The gNB may tell the UE what the set should be (i.e. which precoders may be used per sub-band, or which precoder patterns may be used across the band). In this example embodiment, there may be two options for determining the TPMI.

Optionally, the gNB may select the TPMI/precoder per sub-band, or the TPMI/precoder pattern, based on SRS. The UE may send SRS, and the gNB may signal to the UE the TPMI that selects the precoder or precoder pattern from the set that was signaled to the UE.

Optionally, the UE may select the TPMI/precoder per sub-band, or the TPMI/precoder pattern, for example based on DL-CSI-RS. The UE may measure DL CSI-RS and determine the precoder to use, from the signaled set, based, at least partially, on the DL CSI-RS. In other words, the SRS may be used to determine the overall set of precoders (by the gNB and signaled to the UE), but the SRS may not be used for determining the TPMI to be used for PUSCH transmission.

Where the UE selects the best TPMI/precoder based on the DL-CSI-RS, whether in the case where sub-band specific TPMI sets or TPMI patterns are defined in codebooks or the sub-band specific TPMI sets or TPMI patterns are adaptively signaled by the NW to the UE, the UE may need to determine both the rank indicator (RI) and the TPMI. The RI may indicate the number of layers to be used on the PUSCH. The gNB may not need to know the precoder to receive the PUSCH, but if the UE is determining the RI based on DL-CSI-RS, then the gNB may need to know the RI that the UE selected. In the case where the UE leverages the CSI-RS to select TPMI, there may be two options. In one option, the UE may select the RI and inform the gNB of the selected RI. In another option, the gNB may determine the RI (e.g., based on SRS, etc.) and inform the UE of the RI, and the UE may determine the best TPMI assuming the RI indicated by the gNB.

In an example embodiment, the UE may receive CSI-RS from the gNB. Based on the received CSI-RS, the UE may estimate the downlink channel matrix across the bandwidth of the transmitted CSI-RS. The UE may assume UL/DL reciprocity, and estimate the uplink channel response as the transpose of the DL channel matrix response. This assumption may be reasonable when we are leveraging precoders that are selection entries (1s and zeros) and we are not expecting to use the UL precoders to coherently combine a layer to be transmitted across multiple UE TX antennas.

The UE may compute the best rank indicator (RI) and TPMI from the indicated codebook. Where the codebook comprises a set of precoders per sub-band, the UE may loop over, or evaluate, each possible RI. For each RI, the UE may loop over, or evaluate, each sub-band based on the estimated UL channel to the gNB. For each sub-band, the UE may compute the precoder that is estimated to deliver the highest spectral efficiency while preserving favorable TX power characteristics and efficiency (e.g., roughly equivalent total power on each of the active TX antennas). The UE may, for each RI, sum up the spectral efficiencies of the sub-bands based on the estimated UL channel to the gNB.

The UE may select the RI and set of sub-band precoders that were estimated to deliver the highest spectral efficiency across all sub-bands while preserving favorable TX power characteristics and efficiency. For example, the UE may compare metrics of a set of best precoders (e.g. best precoder determined for each sub-band) determined for a first RI, and metrics of a set of best precoders determined for a second RI, and select the RI with the best metrics, along with the accompanying best set of precoders.

Spectral efficiency may be considered a criteria for selecting PMI, TPMI, TPMI patterns, etc. Additionally or alternatively, a signal to interference plus noise ratio (SINR) may be considered a criteria for selecting PMI, TPMI, TPMI patterns, etc. Criteria for selecting PMI, TPMI, TPMI patterns, etc. may be based, at least partially, on SINR, or a spectral efficiency based on the measured DL channel and/or estimated UL channel.

Where the codebook comprises K sets of TPMI patterns, the UE may loop over, or evaluate, each possible RI. For each RI, the UE may loop over, or evaluate, each possible TPMI pattern based on the estimated UL channel to the gNB. For each TPMI pattern, the UE may leverage the estimated UL channel response to compute the sum spectral efficiency across all sub-bands for that TPMI pattern.

The UE may select the best RI and TPMI pattern that is estimated to result in the highest spectral efficiency. In this case, the assumption may be that the K sets of TPMI patterns have been designed such that all sets have favorable TX power characteristics. If not, then the selection of the best RI and TPMI pattern may be done so that the TX power characteristics are favorable.

If the gNB selects the RI, rather than the UE, then the gNB may inform the UE of the RI, and the UE may perform the above steps assuming the RI received from the gNB. In other words, the UE may evaluate precoders in a sub-band specific set, or TPMI patterns, for a single RI, and select the precoders or precoder pattern having the best spectral efficiency.

If the UE selects the RI, then the UE may inform the gNB of the selected RI. After determining the precoders or precoder pattern to be used, the UE may transmit the PUSCH with the selected RI and the selected precoder.

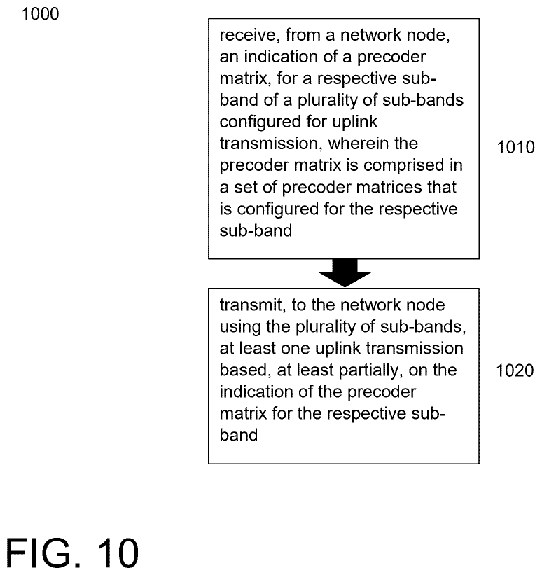

FIG. 10 illustrates the potential steps of an example method 1000. The example method 1000 may include: receiving, from a network node, an indication of a precoder matrix, for a respective sub-band of a plurality of sub-bands configured for uplink transmission, wherein the precoder matrix is comprised in a set of precoder matrices that is configured for the respective sub-band, 1010; and transmitting, to the network node using the plurality of sub-bands, at least one uplink transmission based, at least partially, on the indication of the precoder matrix for the respective sub-band, 1020. The example method 1000 may be performed, for example, with a UE.

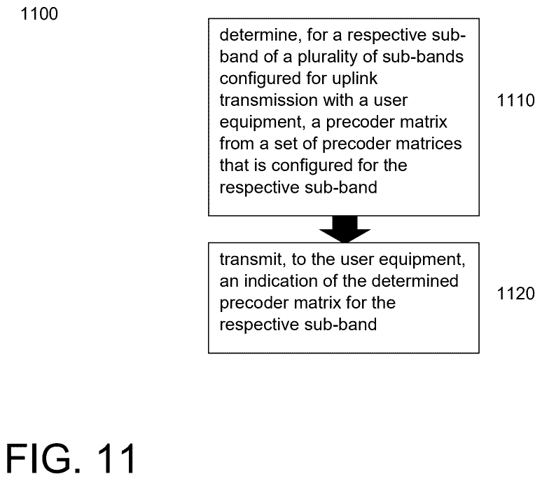

FIG. 11 illustrates the potential steps of an example method 1100. The example method 1100 may include: determining, for a respective sub-band of a plurality of sub-bands configured for uplink transmission with a user equipment, a precoder matrix from a set of precoder matrices that is configured for the respective sub-band, 1110; and transmitting, to the user equipment, an indication of the determined precoder matrix for the respective sub-band, 1120. The example method 1100 may be performed, for example, with a base station, a network node, a gNB, etc.

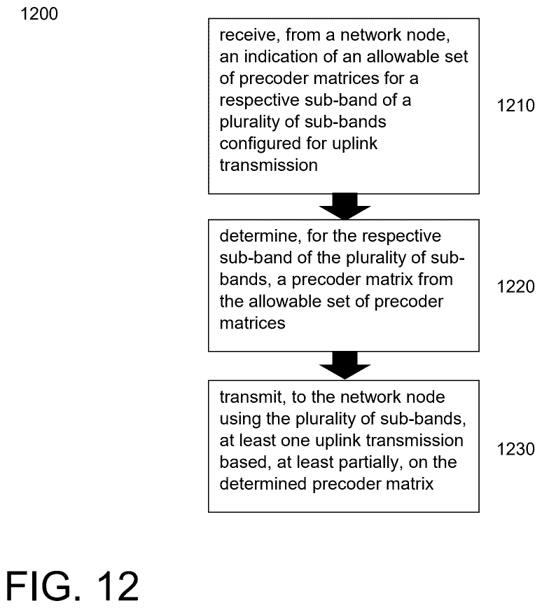

FIG. 12 illustrates the potential steps of an example method 1200. The example method 1200 may include: receiving, from a network node, an indication of an allowable set of precoder matrices for a respective sub-band of a plurality of sub-bands configured for uplink transmission, 1210; determining, for the respective sub-band of the plurality of sub-bands, a precoder matrix from the allowable set of precoder matrices, 1220; and transmitting, to the network node using the plurality of sub-bands, at least one uplink transmission based, at least partially, on the determined precoder matrix, 1230. The example method 1200 may be performed, for example, with a UE.

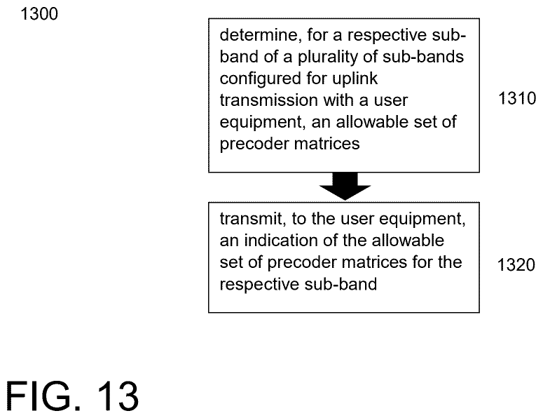

FIG. 13 illustrates the potential steps of an example method 1300. The example method 1300 may include: determining, for a respective sub-band of a plurality of sub-bands configured for uplink transmission with a user equipment, an allowable set of precoder matrices, 1310; and transmitting, to the user equipment, an indication of the allowable set of precoder matrices for the respective sub-band, 1320. The example method 1300 may be performed, for example, with a base station, a network node, a gNB, etc.

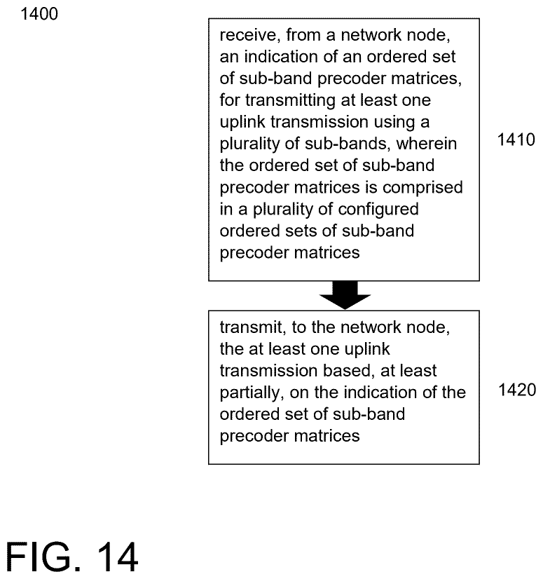

FIG. 14 illustrates the potential steps of an example method 1400. The example method 1400 may include: receiving, from a network node, an indication of an ordered set of sub-band precoder matrices, for transmitting at least one uplink transmission using a plurality of sub-bands, wherein the ordered set of sub-band precoder matrices is comprised in a plurality of configured ordered sets of sub-band precoder matrices, 1410; and transmitting, to the network node, the at least one uplink transmission based, at least partially, on the indication of the ordered set of sub-band precoder matrices, 1420. The example method 1400 may be performed, for example, with a UE.

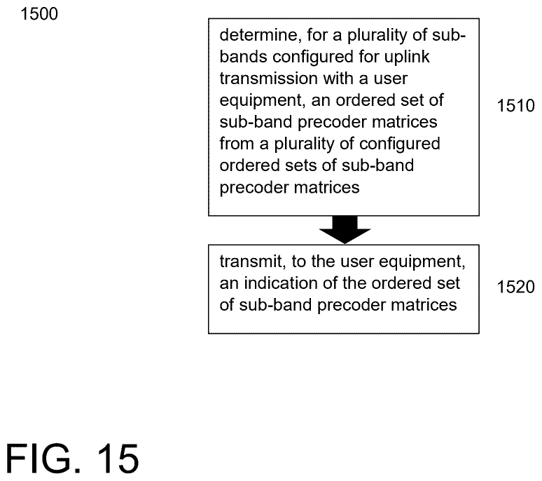

FIG. 15 illustrates the potential steps of an example method 1500. The example method 1500 may include: determining, for a plurality of sub-bands configured for uplink transmission with a user equipment, an ordered set of sub-band precoder matrices from a plurality of configured ordered sets of sub-band precoder matrices, 1510; and transmitting, to the user equipment, an indication of the ordered set of sub-band precoder matrices, 1520. The example method 1500 may be performed, for example, with a base station, a network node, a gNB, etc.

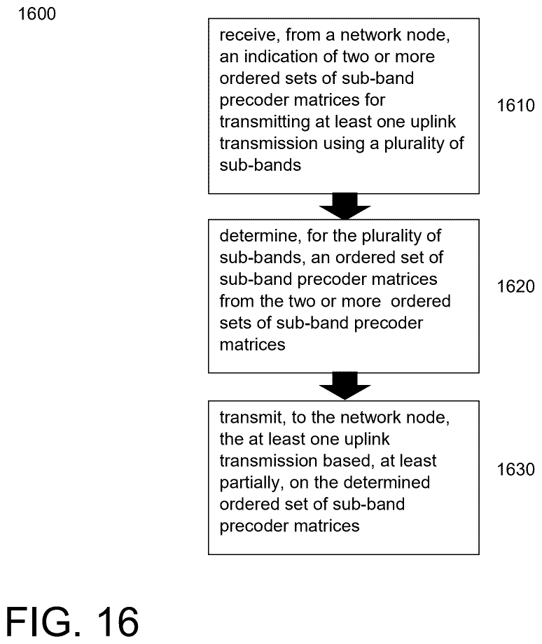

FIG. 16 illustrates the potential steps of an example method 1600. The example method 1600 may include: receiving, from a network node, an indication of two or more ordered sets of sub-band precoder matrices for transmitting at least one uplink transmission using a plurality of sub-bands, 1610; determining, for the plurality of sub-bands, an ordered set of sub-band precoder matrices from the two or more ordered sets of sub-band precoder matrices, 1620; and transmitting, to the network node, the at least one uplink transmission based, at least partially, on the determined ordered set of sub-band precoder matrices, 1630. The example method 1600 may be performed, for example, with a UE.

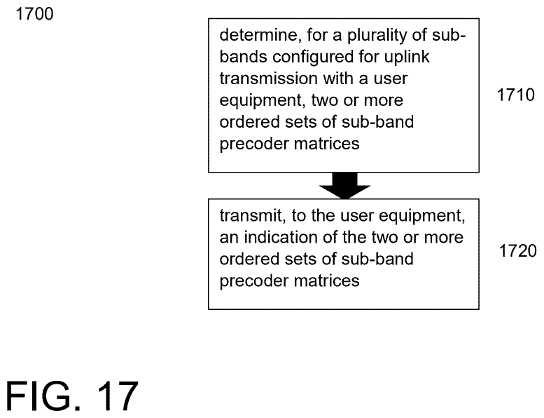

FIG. 17 illustrates the potential steps of an example method 1700. The example method 1700 may include: determining, for a plurality of sub-bands configured for uplink transmission with a user equipment, two or more ordered sets of sub-band precoder matrices, 1710; and transmitting, to the user equipment, an indication of the two or more ordered sets of sub-band precoder matrices, 1720. The example method 1700 may be performed, for example, with a base station, a network node, a gNB, etc.

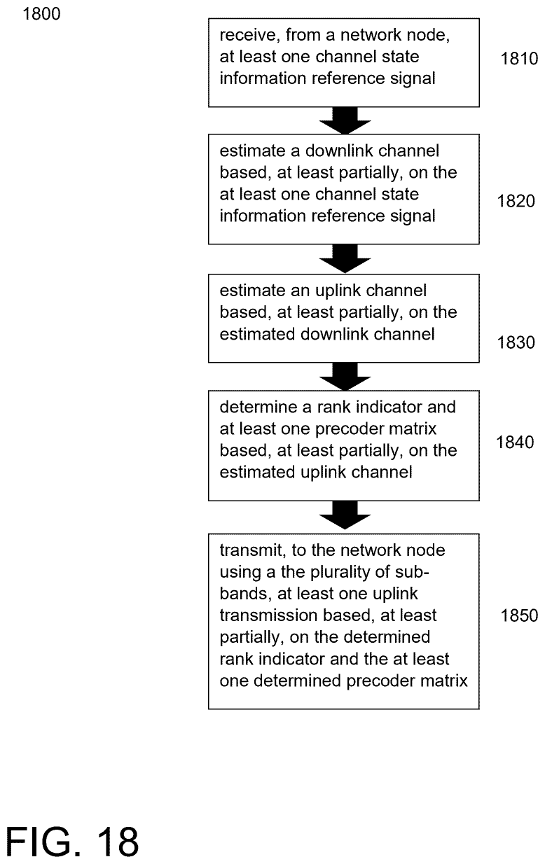

FIG. 18 illustrates the potential steps of an example method 1800. The example method 1800 may include: receiving, from a network node, at least one channel state information reference signal, 1810; estimating a downlink channel based, at least partially, on the at least one channel state information reference signal, 1820; estimating an uplink channel based, at least partially, on the estimated downlink channel, 1830; determining a rank indicator and at least one precoder matrix based, at least partially, on the estimated uplink channel, 1840; and transmitting, to the network node using the plurality of sub-bands, at least one uplink transmission based, at least partially, on the determined rank indicator and the at least one determined precoder matrix, 1850. The at least one precoder matrix may comprise at least one of: a precoder matrix comprised in one of: a set of precoder matrices configured for a sub-band of a plurality of sub-bands configured for uplink transmission, or a set of precoder matrices indicated, by the network node, for the sub-band of the plurality of sub-bands, or an ordered set of sub-band precoder matrices comprised in one of: a plurality of configured ordered sets of sub-band precoder matrices, or a plurality of ordered sets of sub-band precoder matrices indicated by the network node. The example method 1800 may be performed, for example, with a UE.

In accordance with one example embodiment, an apparatus may comprise: at least one processor; and at least one memory storing instructions that, when executed by the at least one processor, cause the apparatus at least to: receive, from a network node, an indication of a precoder matrix, for a respective sub-band of a plurality of sub-bands configured for uplink transmission, wherein the precoder matrix may be comprised in a set of precoder matrices that is configured for the respective sub-band; and transmit, to the network node using the plurality of sub-bands, at least one uplink transmission based, at least partially, on the indication of the precoder matrix for the respective sub-band. The plurality of sub-bands configured for uplink transmission may comprise a plurality of sub-bands configured for physical uplink shared channel transmission. The indication of the precoder matrix for the respective sub-band may comprise a transmit precoder matrix index. The indication of the precoder matrix for the respective sub-band may be received at least one of: with an allocation of uplink resources, via dedicated signaling, via medium access control signaling, or via downlink control information. Transmitting the at least one uplink transmission may comprise the example apparatus being further configured to: transmit the at least one uplink transmission via the respective sub-band using the indicated precoder matrix; and transmit the at least one uplink transmission via a second sub-band of the plurality of sub-bands using a second precoder matrix. The set of precoder matrices that is configured for the respective sub-band may be at least partially different from a set of precoder matrices configured for the second sub-band. The set of precoder matrices that is configured for the respective sub-band may be the same as a set of precoder matrices configured for the second sub-band. The example apparatus may be further configured to: receive, from the network node, a trigger for performing codebook based sounding reference signal transmission; and transmit, to the network node, at least one sounding reference signal based, at least partially, on the trigger. The set of precoder matrices that is configured for the respective sub-band may comprise non-coherent precoder matrices. The set of precoder matrices that is configured for the respective sub-band, and sets of precoder matrices that are respectively configured for sub-bands of the plurality of sub-bands, may comprise sets of precoder matrices that are configured to enable substantially equal usage of a plurality of transmission antennas of the apparatus across a band comprising the plurality of sub-bands.

In accordance with one example embodiment, an example method may be provided comprising: receiving, with a user equipment from a network node, an indication of a precoder matrix, for a respective sub-band of a plurality of sub-bands configured for uplink transmission, wherein the precoder matrix may be comprised in a set of precoder matrices that is configured for the respective sub-band; and transmitting, to the network node using the plurality of sub-bands, at least one uplink transmission based, at least partially, on the indication of the precoder matrix for the respective sub-band. The plurality of sub-bands configured for uplink transmission may comprise a plurality of sub-bands configured for physical uplink shared channel transmission. The indication of the precoder matrix for the respective sub-band may comprise a transmit precoder matrix index. The indication of the precoder matrix for the respective sub-band may be received at least one of: with an allocation of uplink resources, via dedicated signaling, via medium access control signaling, or via downlink control information. The transmitting of the at least one uplink transmission may comprise: transmitting the at least one uplink transmission via the respective sub-band using the indicated precoder matrix; and transmitting the at least one uplink transmission via a second sub-band of the plurality of sub-bands using a second precoder matrix. The set of precoder matrices that is configured for the respective sub-band may be at least partially different from a set of precoder matrices configured for the second sub-band. The set of precoder matrices that is configured for the respective sub-band may be the same as a set of precoder matrices configured for the second sub-band. The example method may further comprise: receiving, from the network node, a trigger for performing codebook based sounding reference signal transmission; and transmitting, to the network node, at least one sounding reference signal based, at least partially, on the trigger. The set of precoder matrices that is configured for the respective sub-band may comprise non-coherent precoder matrices. The set of precoder matrices that is configured for the respective sub-band, and sets of precoder matrices that are respectively configured for sub-bands of the plurality of sub-bands, may comprise sets of precoder matrices that are configured to enable substantially equal usage of a plurality of transmission antennas of the user equipment across a band comprising the plurality of sub-bands.

In accordance with one example embodiment, an apparatus may comprise: circuitry configured to perform: receiving, with a user equipment from a network node, an indication of a precoder matrix, for a respective sub-band of a plurality of sub-bands configured for uplink transmission, wherein the precoder matrix may be comprised in a set of precoder matrices that is configured for the respective sub-band; and circuitry configured to perform: transmitting, to the network node using the plurality of sub-bands, at least one uplink transmission based, at least partially, on the indication of the precoder matrix for the respective sub-band.

In accordance with one example embodiment, an apparatus may comprise: processing circuitry; memory circuitry storing instructions, such as computer readable code, the memory circuitry and the computer readable code configured to, with the processing circuitry, enable the apparatus to: receive, from a network node, an indication of a precoder matrix, for a respective sub-band of a plurality of sub-bands configured for uplink transmission, wherein the precoder matrix may be comprised in a set of precoder matrices that is configured for the respective sub-band; and transmit, to the network node using the plurality of sub-bands, at least one uplink transmission based, at least partially, on the indication of the precoder matrix for the respective sub-band.

As used in this application, the term “circuitry” or “means” may refer to one or more or all of the following: (a) hardware-only circuit implementations (such as implementations in analog, digital and/or quantum circuitry) and (b) combinations of hardware circuit(s) and software, such as (as applicable): (i) a combination of analog, digital and/or quantum hardware circuit(s) with software/firmware and (ii) any or all portions of hardware processor(s) (including digital and/or quantum processor(s)) with software, and memory(ies) that work together to cause an apparatus, such as a mobile device, computing device, or server, to perform various functions) and (c) any or all portions of hardware circuit(s), such as a microprocessor(s), processor(s) and/or quantum processor(s), that requires software (e.g., firmware) for operation, but the software may not be present when it is not needed for operation. This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

In accordance with one example embodiment, an apparatus may comprise means for causing the apparatus to perform at least: receiving, from a network node, an indication of a precoder matrix, for a respective sub-band of a plurality of sub-bands configured for uplink transmission, wherein the precoder matrix may be comprised in a set of precoder matrices that is configured for the respective sub-band; and transmitting, to the network node using the plurality of sub-bands, at least one uplink transmission based, at least partially, on the indication of the precoder matrix for the respective sub-band. The plurality of sub-bands configured for uplink transmission may comprise a plurality of sub-bands configured for physical uplink shared channel transmission. The indication of the precoder matrix for the respective sub-band may comprise a transmit precoder matrix index. The indication of the precoder matrix for the respective sub-band may be received at least one of: with an allocation of uplink resources, via dedicated signaling, via medium access control signaling, or via downlink control information. The means configured for causing the apparatus to perform transmitting the at least one uplink transmission may comprise means for causing the apparatus to perform: transmitting the at least one uplink transmission via the respective sub-band using the indicated precoder matrix; and transmitting the at least one uplink transmission via a second sub-band of the plurality of sub-bands using a second precoder matrix. The set of precoder matrices that is configured for the respective sub-band may be at least partially different from a set of precoder matrices configured for the second sub-band. The set of precoder matrices that is configured for the respective sub-band may be the same as a set of precoder matrices configured for the second sub-band. The means may be further configured for causing the apparatus to perform: receiving, from the network node, a trigger for performing codebook based sounding reference signal transmission; and transmitting, to the network node, at least one sounding reference signal based, at least partially, on the trigger. The set of precoder matrices that is configured for the respective sub-band may comprise non-coherent precoder matrices. The set of precoder matrices that is configured for the respective sub-band, and sets of precoder matrices that are respectively configured for sub-bands of the plurality of sub-bands, may comprise sets of precoder matrices that are configured to enable substantially equal usage of a plurality of transmission antennas of the apparatus across a band comprising the plurality of sub-bands.

A processor, memory, and/or example algorithms (which may be encoded as instructions, program, or code) may be provided as example means for providing or causing performance of operation.

In accordance with one example embodiment, a (non-transitory) computer-readable medium comprising instructions stored thereon which, when executed with at least one processor, cause the at least one processor to: cause receiving, with a user equipment from a network node, of an indication of a precoder matrix, for a respective sub-band of a plurality of sub-bands configured for uplink transmission, wherein the precoder matrix may be comprised in a set of precoder matrices that is configured for the respective sub-band; and cause transmitting, to the network node using the plurality of sub-bands, of at least one uplink transmission based, at least partially, on the indication of the precoder matrix for the respective sub-band.

In accordance with one example embodiment, a (non-transitory) computer-readable medium comprising instructions stored thereon for performing at least the following: causing receiving, with a user equipment from a network node, of an indication of a precoder matrix, for a respective sub-band of a plurality of sub-bands configured for uplink transmission, wherein the precoder matrix may be comprised in a set of precoder matrices that is configured for the respective sub-band; and causing transmitting, to the network node using the plurality of sub-bands, of at least one uplink transmission based, at least partially, on the indication of the precoder matrix for the respective sub-band. The plurality of sub-bands configured for uplink transmission may comprise a plurality of sub-bands configured for physical uplink shared channel transmission. The indication of the precoder matrix for the respective sub-band may comprise a transmit precoder matrix index. The indication of the precoder matrix for the respective sub-band may be received at least one of: with an allocation of uplink resources, via dedicated signaling, via medium access control signaling, or via downlink control information. The instructions stored thereon for performing causing transmitting of the at least one uplink transmission may comprise instructions for performing: causing transmitting of the at least one uplink transmission via the respective sub-band using the indicated precoder matrix; and causing transmitting of the at least one uplink transmission via a second sub-band of the plurality of sub-bands using a second precoder matrix. The set of precoder matrices that is configured for the respective sub-band may be at least partially different from a set of precoder matrices configured for the second sub-band. The set of precoder matrices that is configured for the respective sub-band may be the same as a set of precoder matrices configured for the second sub-band. The example computer-readable medium may further comprise instructions stored thereon for performing: causing receiving, from the network node, of a trigger for performing codebook based sounding reference signal transmission; and causing transmitting, to the network node, of at least one sounding reference signal based, at least partially, on the trigger. The set of precoder matrices that is configured for the respective sub-band may comprise non-coherent precoder matrices. The set of precoder matrices that is configured for the respective sub-band, and sets of precoder matrices that are respectively configured for sub-bands of the plurality of sub-bands, may comprise sets of precoder matrices that are configured to enable substantially equal usage of a plurality of transmission antennas of the user equipment across a band comprising the plurality of sub-bands.

In accordance with one example embodiment, a (non-transitory) program storage device readable by a machine may be provided, tangibly embodying instructions executable by the machine for performing operations, the operations comprising: causing receiving, with a user equipment from a network node, of an indication of a precoder matrix, for a respective sub-band of a plurality of sub-bands configured for uplink transmission, wherein the precoder matrix may be comprised in a set of precoder matrices that is configured for the respective sub-band; and causing transmitting, to the network node using the plurality of sub-bands, of at least one uplink transmission based, at least partially, on the indication of the precoder matrix for the respective sub-band.

In accordance with one example embodiment, a (non-transitory) computer-readable medium comprising instructions that, when executed by an apparatus, cause the apparatus to perform at least the following: causing receiving, with a user equipment from a network node, of an indication of a precoder matrix, for a respective sub-band of a plurality of sub-bands configured for uplink transmission, wherein the precoder matrix may be comprised in a set of precoder matrices that is configured for the respective sub-band; and causing transmitting, to the network node using the plurality of sub-bands, of at least one uplink transmission based, at least partially, on the indication of the precoder matrix for the respective sub-band.

In accordance with one example embodiment, a computer implemented system comprising: at least one processor and at least one (non-transitory) memory storing instructions that, when executed by the at least one processor, cause the system at least to perform: causing receiving, with a user equipment from a network node, of an indication of a precoder matrix, for a respective sub-band of a plurality of sub-bands configured for uplink transmission, wherein the precoder matrix may be comprised in a set of precoder matrices that is configured for the respective sub-band; and causing transmitting, to the network node using the plurality of sub-bands, of at least one uplink transmission based, at least partially, on the indication of the precoder matrix for the respective sub-band.

In accordance with one example embodiment, a computer implemented system comprising: means for causing receiving, with a user equipment from a network node, of an indication of a precoder matrix, for a respective sub-band of a plurality of sub-bands configured for uplink transmission, wherein the precoder matrix may be comprised in a set of precoder matrices that is configured for the respective sub-band; and means for causing transmitting, to the network node using the plurality of sub-bands, of at least one uplink transmission based, at least partially, on the indication of the precoder matrix for the respective sub-band.

In accordance with one example embodiment, an apparatus may comprise: at least one processor; and at least one memory storing instructions that, when executed by the at least one processor, cause the apparatus at least to: determine, for a respective sub-band of a plurality of sub-bands configured for uplink transmission with a user equipment, a precoder matrix from a set of precoder matrices that is configured for the respective sub-band; and transmit, to the user equipment, an indication of the determined precoder matrix for the respective sub-band. Determining the precoder matrix for the respective sub-band may comprise the example apparatus being further configured to: receive, from the user equipment, at least one sounding reference signal; and determine the precoder matrix for the respective sub-band based, at least partially, on the at least one received sounding reference signal. The example apparatus may be further configured to: transmit, to the user equipment, a trigger for performing codebook based sounding reference signal transmission. The plurality of sub-bands configured for uplink transmission with the user equipment may comprise a plurality of sub-bands configured for physical uplink shared channel transmission. The indication of the determined precoder matrix for the respective sub-band may comprise a transmit precoder matrix index. The indication of the determined precoder matrix for the respective sub-band may be transmitted at least one of: with an allocation of uplink resources, via dedicated signaling, via medium access control signaling, or via downlink control information. The example apparatus may be further configured to: determine, for a second sub-band of the plurality of sub-bands, a second precoder matrix from a second set of precoder matrices that may be configured for the second sub-band; and transmit, to the user equipment, an indication of the determined second precoder matrix for the second sub-band. The set of precoder matrices that is configured for the respective sub-band may be at least partially different from the second set of precoder matrices that is configured for the second sub-band. The set of precoder matrices that is configured for the respective sub-band may be the same as the second set of precoder matrices that is configured for the second sub-band. The set of precoder matrices that is configured for the respective sub-band may comprise non-coherent precoder matrices. The set of precoder matrices that is configured for the respective sub-band, and sets of precoder matrices that are respectively configured for sub-bands of the plurality of sub-bands, may comprise sets of precoder matrices that are configured to enable substantially equal usage of a plurality of transmission antennas of the user equipment across a band comprising the plurality of sub-bands.

In accordance with one example embodiment, an example method may be provided comprising: determining, with a network node for a respective sub-band of a plurality of sub-bands configured for uplink transmission with a user equipment, a precoder matrix from a set of precoder matrices that is configured for the respective sub-band; and transmitting, to the user equipment, an indication of the determined precoder matrix for the respective sub-band. The determining of the precoder matrix for the respective sub-band may comprise: receiving, from the user equipment, at least one sounding reference signal; and determining the precoder matrix for the respective sub-band based, at least partially, on the at least one received sounding reference signal. The example method may further comprise: transmitting, to the user equipment, a trigger for performing codebook based sounding reference signal transmission. The plurality of sub-bands configured for uplink transmission with the user equipment may comprise a plurality of sub-bands configured for physical uplink shared channel transmission. The indication of the determined precoder matrix for the respective sub-band may comprise a transmit precoder matrix index. The indication of the determined precoder matrix for the respective sub-band may be transmitted at least one of: with an allocation of uplink resources, via dedicated signaling, via medium access control signaling, or via downlink control information. The example method may further comprise: determining, for a second sub-band of the plurality of sub-bands, a second precoder matrix from a second set of precoder matrices that is configured for the second sub-band; and transmitting, to the user equipment, an indication of the determined second precoder matrix for the second sub-band. The set of precoder matrices that is configured for the respective sub-band may be at least partially different from the second set of precoder matrices that is configured for the second sub-band. The set of precoder matrices that is configured for the respective sub-band may be the same as the second set of precoder matrices that is configured for the second sub-band. The set of precoder matrices that is configured for the respective sub-band may comprise non-coherent precoder matrices. The set of precoder matrices that is configured for the respective sub-band, and sets of precoder matrices that are respectively configured for sub-bands of the plurality of sub-bands, may comprise sets of precoder matrices that are configured to enable substantially equal usage of a plurality of transmission antennas of the user equipment across a band comprising the plurality of sub-bands.

In accordance with one example embodiment, an apparatus may comprise: circuitry configured to perform: determining, with a network node for a respective sub-band of a plurality of sub-bands configured for uplink transmission with a user equipment, a precoder matrix from a set of precoder matrices that is configured for the respective sub-band; and circuitry configured to perform: transmitting, to the user equipment, an indication of the determined precoder matrix for the respective sub-band.

In accordance with one example embodiment, an apparatus may comprise: processing circuitry; memory circuitry storing instructions, such as computer readable code, the memory circuitry and the computer readable code configured to, with the processing circuitry, enable the apparatus to: determine, for a respective sub-band of a plurality of sub-bands configured for uplink transmission with a user equipment, a precoder matrix from a set of precoder matrices that is configured for the respective sub-band; and transmit, to the user equipment, an indication of the determined precoder matrix for the respective sub-band.

In accordance with one example embodiment, an apparatus may comprise means for causing the apparatus to perform at least: determining, for a respective sub-band of a plurality of sub-bands configured for uplink transmission with a user equipment, a precoder matrix from a set of precoder matrices that is configured for the respective sub-band; and transmitting, to the user equipment, an indication of the determined precoder matrix for the respective sub-band. The means configured for causing the apparatus to perform determining the precoder matrix for the respective sub-band may comprise means for causing the apparatus to perform: receiving, from the user equipment, at least one sounding reference signal; and determining the precoder matrix for the respective sub-band based, at least partially, on the at least one received sounding reference signal. The means may be further configured for causing the apparatus to perform: transmitting, to the user equipment, a trigger for performing codebook based sounding reference signal transmission. The plurality of sub-bands configured for uplink transmission with the user equipment may comprise a plurality of sub-bands configured for physical uplink shared channel transmission. The indication of the determined precoder matrix for the respective sub-band may comprise a transmit precoder matrix index. The indication of the determined precoder matrix for the respective sub-band may be transmitted at least one of: with an allocation of uplink resources, via dedicated signaling, via medium access control signaling, or via downlink control information. The means may be further configured for causing the apparatus to perform: determining, for a second sub-band of the plurality of sub-bands, a second precoder matrix from a second set of precoder matrices that is configured for the second sub-band; and transmitting, to the user equipment, an indication of the determined second precoder matrix for the second sub-band. The set of precoder matrices that is configured for the respective sub-band may be at least partially different from the second set of precoder matrices that is configured for the second sub-band. The set of precoder matrices that is configured for the respective sub-band may be the same as the second set of precoder matrices that is configured for the second sub-band. The set of precoder matrices that is configured for the respective sub-band may comprise non-coherent precoder matrices. The set of precoder matrices that is configured for the respective sub-band, and sets of precoder matrices that are respectively configured for sub-bands of the plurality of sub-bands, may comprise sets of precoder matrices that are configured to enable substantially equal usage of a plurality of transmission antennas of the user equipment across a band comprising the plurality of sub-bands.

In accordance with one example embodiment, a (non-transitory) computer-readable medium comprising instructions stored thereon which, when executed with at least one processor, cause the at least one processor to: cause determining, with a network node for a respective sub-band of a plurality of sub-bands configured for uplink transmission with a user equipment, of a precoder matrix from a set of precoder matrices that is configured for the respective sub-band; and cause transmitting, to the user equipment, of an indication of the determined precoder matrix for the respective sub-band.

In accordance with one example embodiment, a (non-transitory) computer-readable medium comprising instructions stored thereon for performing at least the following: causing determining, with a network node for a respective sub-band of a plurality of sub-bands configured for uplink transmission with a user equipment, of a precoder matrix from a set of precoder matrices that is configured for the respective sub-band; and causing transmitting, to the user equipment, of an indication of the determined precoder matrix for the respective sub-band. The instructions stored thereon for performing determining the precoder matrix for the respective sub-band may comprise instructions for performing: causing receiving, from the user equipment, of at least one sounding reference signal; and determining the precoder matrix for the respective sub-band based, at least partially, on the at least one received sounding reference signal. The example computer-readable medium may further comprise instructions stored thereon for performing: causing transmitting, to the user equipment, of a trigger for performing codebook based sounding reference signal transmission. The plurality of sub-bands configured for uplink transmission with the user equipment may comprise a plurality of sub-bands configured for physical uplink shared channel transmission. The indication of the determined precoder matrix for the respective sub-band may comprise a transmit precoder matrix index. The indication of the determined precoder matrix for the respective sub-band may be transmitted at least one of: with an allocation of uplink resources, via dedicated signaling, via medium access control signaling, or via downlink control information. The example computer-readable medium may further comprise instructions stored thereon for performing: determining, for a second sub-band of the plurality of sub-bands, a second precoder matrix from a second set of precoder matrices that is configured for the second sub-band; and causing transmitting, to the user equipment, of an indication of the determined second precoder matrix for the second sub-band. The set of precoder matrices that is configured for the respective sub-band may be at least partially different from the second set of precoder matrices that is configured for the second sub-band. The set of precoder matrices that is configured for the respective sub-band may be the same as the second set of precoder matrices that is configured for the second sub-band. The set of precoder matrices that is configured for the respective sub-band may comprise non-coherent precoder matrices. The set of precoder matrices that is configured for the respective sub-band, and sets of precoder matrices that are respectively configured for sub-bands of the plurality of sub-bands, may comprise sets of precoder matrices that are configured to enable substantially equal usage of a plurality of transmission antennas of the user equipment across a band comprising the plurality of sub-bands.

In accordance with one example embodiment, a (non-transitory) program storage device readable by a machine may be provided, tangibly embodying instructions executable by the machine for performing operations, the operations comprising: causing determining, with a network node for a respective sub-band of a plurality of sub-bands configured for uplink transmission with a user equipment, of a precoder matrix from a set of precoder matrices that is configured for the respective sub-band; and causing transmitting, to the user equipment, of an indication of the determined precoder matrix for the respective sub-band.

In accordance with one example embodiment, a (non-transitory) computer-readable medium comprising instructions that, when executed by an apparatus, cause the apparatus to perform at least the following: causing determining, with a network node for a respective sub-band of a plurality of sub-bands configured for uplink transmission with a user equipment, of a precoder matrix from a set of precoder matrices that is configured for the respective sub-band; and causing transmitting, to the user equipment, of an indication of the determined precoder matrix for the respective sub-band.

In accordance with one example embodiment, a computer implemented system comprising: at least one processor and at least one (non-transitory) memory storing instructions that, when executed by the at least one processor, cause the system at least to perform: causing determining, with a network node for a respective sub-band of a plurality of sub-bands configured for uplink transmission with a user equipment, of a precoder matrix from a set of precoder matrices that is configured for the respective sub-band; and causing transmitting, to the user equipment, of an indication of the determined precoder matrix for the respective sub-band.

In accordance with one example embodiment, a computer implemented system comprising: means for causing determining, with a network node for a respective sub-band of a plurality of sub-bands configured for uplink transmission with a user equipment, of a precoder matrix from a set of precoder matrices that is configured for the respective sub-band; and means for causing transmitting, to the user equipment, of an indication of the determined precoder matrix for the respective sub-band.

In accordance with one example embodiment, an apparatus may comprise: at least one processor; and at least one memory storing instructions that, when executed by the at least one processor, cause the apparatus at least to: receive, from a network node, an indication of an allowable set of precoder matrices for a respective sub-band of a plurality of sub-bands configured for uplink transmission; determine, for the respective sub-band of the plurality of sub-bands, a precoder matrix from the allowable set of precoder matrices; and transmit, to the network node using the plurality of sub-bands, at least one uplink transmission based, at least partially, on the determined precoder matrix. The plurality of sub-bands configured for uplink transmission may comprise a plurality of sub-bands configured for physical uplink shared channel transmission. The indication of the allowable set of precoder matrices for the respective sub-band may be received at least one of: with an allocation of uplink resources, via dedicated signaling, via medium access control signaling, or via downlink control information. The precoder matrix for the respective sub-band may be determined based, at least partially, on at least one of: transmission power associated with precoder matrices in the allowable set of precoder matrices for the respective sub-band, a status of at least one transmission antenna associated with the precoder matrices in the allowable set of precoder matrices for the respective sub-band, a downlink channel between the network node and the apparatus, or at least one downlink channel state information reference signal. Determining, for the respective sub-band of the plurality of sub-bands, the precoder matrix from the allowable set of precoder matrices may comprise the example apparatus being further configured to: receive, from the network node, an indication of the precoder matrix within the allowable set of precoder matrices. The indication of the precoder matrix may comprise a transmit precoder matrix index. The indication of the precoder matrix within the allowable set of precoder matrices may be received at least one of: with an allocation of uplink resources, via dedicated signaling, via medium access control signaling, or via downlink control information. The example apparatus may be further configured to: receive, from the network node, an indication of a second allowable set of precoder matrices for a second sub-band of the plurality of sub-bands. The allowable set of precoder matrices for the respective sub-band may be at least partially different from the second allowable set of precoder matrices for the second sub-band. The allowable set of precoder matrices for the respective sub-band may be the same as the second allowable set of precoder matrices for the second sub-band. The example apparatus may be further configured to: receive, from the network node, a trigger for performing codebook based sounding reference signal transmission; and transmit, to the network node, at least one sounding reference signal based, at least partially, on the trigger. The allowable set of precoder matrices for the respective sub-band may comprise non-coherent precoder matrices. The allowable set of precoder matrices for the respective sub-band, and allowable sets of precoder matrices respectively associated with sub-bands of the plurality of sub-bands, may comprise sets of precoder matrices that are configured to enable substantially equal usage of a plurality of transmission antennas of the apparatus across a band comprising the plurality of sub-bands.

In accordance with one example embodiment, an example method may be provided comprising: receiving, with a user equipment from a network node, an indication of an allowable set of precoder matrices for a respective sub-band of a plurality of sub-bands configured for uplink transmission; determining, for the respective sub-band of the plurality of sub-bands, a precoder matrix from the allowable set of precoder matrices; and transmitting, to the network node using the plurality of sub-bands, at least one uplink transmission based, at least partially, on the determined precoder matrix. The plurality of sub-bands configured for uplink transmission may comprise a plurality of sub-bands configured for physical uplink shared channel transmission. The indication of the allowable set of precoder matrices for the respective sub-band may be received at least one of: with an allocation of uplink resources, via dedicated signaling, via medium access control signaling, or via downlink control information. The precoder matrix for the respective sub-band may be determined based, at least partially, on at least one of: transmission power associated with precoder matrices in the allowable set of precoder matrices for the respective sub-band, a status of at least one transmission antenna associated with the precoder matrices in the allowable set of precoder matrices for the respective sub-band, a downlink channel between the network node and the user equipment, or at least one downlink channel state information reference signal. The determining, for the respective sub-band of the plurality of sub-bands, of the precoder matrix from the allowable set of precoder matrices may comprise: receiving, from the network node, an indication of the precoder matrix within the allowable set of precoder matrices. The indication of the precoder matrix may comprise a transmit precoder matrix index. The indication of the precoder matrix within the allowable set of precoder matrices may be received at least one of: with an allocation of uplink resources, via dedicated signaling, via medium access control signaling, or via downlink control information. The example method may further comprise: receiving, from the network node, an indication of a second allowable set of precoder matrices for a second sub-band of the plurality of sub-bands. The allowable set of precoder matrices for the respective sub-band may be at least partially different from the second allowable set of precoder matrices for the second sub-band. The allowable set of precoder matrices for the respective sub-band may be the same as the second allowable set of precoder matrices for the second sub-band. The example method may further comprise: receiving, from the network node, a trigger for performing codebook based sounding reference signal transmission; and transmitting, to the network node, at least one sounding reference signal based, at least partially, on the trigger. The allowable set of precoder matrices for the respective sub-band may comprise non-coherent precoder matrices. The allowable set of precoder matrices for the respective sub-band, and allowable sets of precoder matrices respectively associated with sub-bands of the plurality of sub-bands, may comprise sets of precoder matrices that are configured to enable substantially equal usage of a plurality of transmission antennas of the user equipment across a band comprising the plurality of sub-bands.

In accordance with one example embodiment, an apparatus may comprise: circuitry configured to perform: receiving, with a user equipment from a network node, an indication of an allowable set of precoder matrices for a respective sub-band of a plurality of sub-bands configured for uplink transmission; circuitry configured to perform: determining, for the respective sub-band of the plurality of sub-bands, a precoder matrix from the allowable set of precoder matrices; and circuitry configured to perform: transmitting, to the network node using the plurality of sub-bands, at least one uplink transmission based, at least partially, on the determined precoder matrix.

In accordance with one example embodiment, an apparatus may comprise: processing circuitry; memory circuitry storing instructions, such as computer readable code, the memory circuitry and the computer readable code configured to, with the processing circuitry, enable the apparatus to: receive, from a network node, an indication of an allowable set of precoder matrices for a respective sub-band of a plurality of sub-bands configured for uplink transmission; determine, for the respective sub-band of the plurality of sub-bands, a precoder matrix from the allowable set of precoder matrices; and transmit, to the network node using the plurality of sub-bands, at least one uplink transmission based, at least partially, on the determined precoder matrix.

In accordance with one example embodiment, an apparatus may comprise means for causing the apparatus to perform at least: receiving, from a network node, an indication of an allowable set of precoder matrices for a respective sub-band of a plurality of sub-bands configured for uplink transmission; determining, for the respective sub-band of the plurality of sub-bands, a precoder matrix from the allowable set of precoder matrices; and transmitting, to the network node using the plurality of sub-bands, at least one uplink transmission based, at least partially, on the determined precoder matrix. The plurality of sub-bands configured for uplink transmission may comprise a plurality of sub-bands configured for physical uplink shared channel transmission. The indication of the allowable set of precoder matrices for the respective sub-band may be received at least one of: with an allocation of uplink resources, via dedicated signaling, via medium access control signaling, or via downlink control information. The precoder matrix for the respective sub-band may be determined based, at least partially, on at least one of: transmission power associated with precoder matrices in the allowable set of precoder matrices for the respective sub-band, a status of at least one transmission antenna associated with the precoder matrices in the allowable set of precoder matrices for the respective sub-band, a downlink channel between the network node and the apparatus, or at least one downlink channel state information reference signal. The means configured for causing the apparatus to perform determining, for the respective sub-band of the plurality of sub-bands, the precoder matrix from the allowable set of precoder matrices may comprise means for causing the apparatus to perform: receiving, from the network node, an indication of the precoder matrix within the allowable set of precoder matrices. The indication of the precoder matrix may comprise a transmit precoder matrix index. The indication of the precoder matrix within the allowable set of precoder matrices may be received at least one of: with an allocation of uplink resources, via dedicated signaling, via medium access control signaling, or via downlink control information. The means may be further configured for causing the apparatus to perform: receiving, from the network node, an indication of a second allowable set of precoder matrices for a second sub-band of the plurality of sub-bands. The allowable set of precoder matrices for the respective sub-band may be at least partially different from the second allowable set of precoder matrices for the second sub-band. The allowable set of precoder matrices for the respective sub-band may be the same as the second allowable set of precoder matrices for the second sub-band. The means may be further configured for causing the apparatus to perform: receiving, from the network node, a trigger for performing codebook based sounding reference signal transmission; and transmitting, to the network node, at least one sounding reference signal based, at least partially, on the trigger. The allowable set of precoder matrices for the respective sub-band may comprise non-coherent precoder matrices. The allowable set of precoder matrices for the respective sub-band, and allowable sets of precoder matrices respectively associated with sub-bands of the plurality of sub-bands, may comprise sets of precoder matrices that are configured to enable substantially equal usage of a plurality of transmission antennas of the apparatus across a band comprising the plurality of sub-bands.

In accordance with one example embodiment, a (non-transitory) computer-readable medium comprising instructions stored thereon which, when executed with at least one processor, cause the at least one processor to: cause receiving, with a user equipment from a network node, of an indication of an allowable set of precoder matrices for a respective sub-band of a plurality of sub-bands configured for uplink transmission; determine, for the respective sub-band of the plurality of sub-bands, a precoder matrix from the allowable set of precoder matrices; and cause transmitting, to the network node using the plurality of sub-bands, of at least one uplink transmission based, at least partially, on the determined precoder matrix.

In accordance with one example embodiment, a (non-transitory) computer-readable medium comprising instructions stored thereon for performing at least the following: causing receiving, with a user equipment from a network node, of an indication of an allowable set of precoder matrices for a respective sub-band of a plurality of sub-bands configured for uplink transmission; determining, for the respective sub-band of the plurality of sub-bands, a precoder matrix from the allowable set of precoder matrices; and causing transmitting, to the network node using the plurality of sub-bands, of at least one uplink transmission based, at least partially, on the determined precoder matrix. The plurality of sub-bands configured for uplink transmission may comprise a plurality of sub-bands configured for physical uplink shared channel transmission. The indication of the allowable set of precoder matrices for the respective sub-band may be received at least one of: with an allocation of uplink resources, via dedicated signaling, via medium access control signaling, or via downlink control information. The precoder matrix for the respective sub-band may be determined based, at least partially, on at least one of: transmission power associated with precoder matrices in the allowable set of precoder matrices for the respective sub-band, a status of at least one transmission antenna associated with the precoder matrices in the allowable set of precoder matrices for the respective sub-band, a downlink channel between the network node and the user equipment, or at least one downlink channel state information reference signal. The instructions stored thereon for performing determining, for the respective sub-band of the plurality of sub-bands, the precoder matrix from the allowable set of precoder matrices may comprise instructions for performing: receiving, from the network node, an indication of the precoder matrix within the allowable set of precoder matrices. The indication of the precoder matrix may comprise a transmit precoder matrix index. The indication of the precoder matrix within the allowable set of precoder matrices may be received at least one of: with an allocation of uplink resources, via dedicated signaling, via medium access control signaling, or via downlink control information. The example computer-readable medium may further comprise instructions stored thereon for performing: causing receiving, from the network node, of an indication of a second allowable set of precoder matrices for a second sub-band of the plurality of sub-bands. The allowable set of precoder matrices for the respective sub-band may be at least partially different from the second allowable set of precoder matrices for the second sub-band. The allowable set of precoder matrices for the respective sub-band may be the same as the second allowable set of precoder matrices for the second sub-band. The example computer-readable medium may further comprise instructions stored thereon for performing: causing receiving, from the network node, of a trigger for performing codebook based sounding reference signal transmission; and causing transmitting, to the network node, of at least one sounding reference signal based, at least partially, on the trigger. The allowable set of precoder matrices for the respective sub-band may comprise non-coherent precoder matrices. The allowable set of precoder matrices for the respective sub-band, and allowable sets of precoder matrices respectively associated with sub-bands of the plurality of sub-bands, may comprise sets of precoder matrices that are configured to enable substantially equal usage of a plurality of transmission antennas of the user equipment across a band comprising the plurality of sub-bands.

In accordance with one example embodiment, a (non-transitory) program storage device readable by a machine may be provided, tangibly embodying instructions executable by the machine for performing operations, the operations comprising: causing receiving, with a user equipment from a network node, of an indication of an allowable set of precoder matrices for a respective sub-band of a plurality of sub-bands configured for uplink transmission; determining, for the respective sub-band of the plurality of sub-bands, a precoder matrix from the allowable set of precoder matrices; and causing transmitting, to the network node using the plurality of sub-bands, of at least one uplink transmission based, at least partially, on the determined precoder matrix.

In accordance with one example embodiment, a (non-transitory) computer-readable medium comprising instructions that, when executed by an apparatus, cause the apparatus to perform at least the following: causing receiving, with a user equipment from a network node, of an indication of an allowable set of precoder matrices for a respective sub-band of a plurality of sub-bands configured for uplink transmission; determining, for the respective sub-band of the plurality of sub-bands, a precoder matrix from the allowable set of precoder matrices; and causing transmitting, to the network node using the plurality of sub-bands, of at least one uplink transmission based, at least partially, on the determined precoder matrix.

In accordance with one example embodiment, a computer implemented system comprising: at least one processor and at least one (non-transitory) memory storing instructions that, when executed by the at least one processor, cause the system at least to perform: causing receiving, with a user equipment from a network node, of an indication of an allowable set of precoder matrices for a respective sub-band of a plurality of sub-bands configured for uplink transmission; determining, for the respective sub-band of the plurality of sub-bands, a precoder matrix from the allowable set of precoder matrices; and causing transmitting, to the network node using the plurality of sub-bands, of at least one uplink transmission based, at least partially, on the determined precoder matrix.

In accordance with one example embodiment, a computer implemented system comprising: means for causing receiving, with a user equipment from a network node, of an indication of an allowable set of precoder matrices for a respective sub-band of a plurality of sub-bands configured for uplink transmission; means for determining, for the respective sub-band of the plurality of sub-bands, a precoder matrix from the allowable set of precoder matrices; and means for causing transmitting, to the network node using the plurality of sub-bands, of at least one uplink transmission based, at least partially, on the determined precoder matrix.

In accordance with one example embodiment, an apparatus may comprise: at least one processor; and at least one memory storing instructions that, when executed by the at least one processor, cause the apparatus at least to: determine, for a respective sub-band of a plurality of sub-bands configured for uplink transmission with a user equipment, an allowable set of precoder matrices; and transmit, to the user equipment, an indication of the allowable set of precoder matrices for the respective sub-band. Determining the allowable set of precoder matrices for the respective sub-band may comprise the example apparatus being further configured to: receive, from the user equipment, at least one sounding reference signal; and determine the allowable set of precoder matrices for the respective sub-band based, at least partially, on the at least one received sounding reference signal. The example apparatus may be further configured to: transmit, to the user equipment, a trigger for performing codebook based sounding reference signal transmission. The plurality of sub-bands configured for uplink transmission may comprise a plurality of sub-bands configured for physical uplink shared channel transmission. The indication of the allowable set of precoder matrices for the respective sub-band may be transmitted at least one of: with an allocation of uplink resources, via dedicated signaling, via medium access control signaling, or via downlink control information. The example apparatus may be further configured to: determine a precoder matrix in the allowable set of precoder matrices for the respective sub-band; and transmit, to the user equipment, an indication of the determined precoder matrix. The precoder matrix in the allowable set of precoder matrices for the respective sub-band may be determined based, at least partially, on at least one received sounding reference signal. The indication of the determined precoder matrix may comprise a transmit precoder matrix index. The indication of the determined precoder matrix may be transmitted at least one of: with an allocation of uplink resources, via dedicated signaling, via medium access control signaling, or via downlink control information. The example apparatus may be further configured to: determine, for a second sub-band of the plurality of sub-bands, a second allowable set of precoder matrices; and transmit, to the user equipment, an indication of the second allowable set of precoder matrices for the second sub-band. The allowable set of precoder matrices for the respective sub-band may be at least partially different from the second allowable set of precoder matrices for the second sub-band. The allowable set of precoder matrices for the respective sub-band may be the same as the second allowable set of precoder matrices for the second sub-band. The allowable set of precoder matrices for the respective sub-band may comprise non-coherent precoder matrices. The allowable set of precoder matrices for the respective sub-band, and allowable sets of precoder matrices respectively associated with sub-bands of the plurality of sub-bands, may comprise sets of precoder matrices that are configured to enable substantially equal usage of a plurality of transmission antennas of the user equipment across a band comprising the plurality of sub-bands.

In accordance with one example embodiment, an example method may be provided comprising: determining, with a network node for a respective sub-band of a plurality of sub-bands configured for uplink transmission with a user equipment, an allowable set of precoder matrices; and transmitting, to the user equipment, an indication of the allowable set of precoder matrices for the respective sub-band. The determining of the allowable set of precoder matrices for the respective sub-band may comprise: receiving, from the user equipment, at least one sounding reference signal; and determining the allowable set of precoder matrices for the respective sub-band based, at least partially, on the at least one received sounding reference signal. The example method may further comprise: transmitting, to the user equipment, a trigger for performing codebook based sounding reference signal transmission. The plurality of sub-bands configured for uplink transmission may comprise a plurality of sub-bands configured for physical uplink shared channel transmission. The indication of the allowable set of precoder matrices for the respective sub-band may be transmitted at least one of: with an allocation of uplink resources, via dedicated signaling, via medium access control signaling, or via downlink control information. The example method may further comprise: determining a precoder matrix in the allowable set of precoder matrices for the respective sub-band; and transmitting, to the user equipment, an indication of the determined precoder matrix. The precoder matrix in the allowable set of precoder matrices for the respective sub-band may be determined based, at least partially, on at least one received sounding reference signal. The indication of the determined precoder matrix may comprise a transmit precoder matrix index. The indication of the determined precoder matrix may be transmitted at least one of: with an allocation of uplink resources, via dedicated signaling, via medium access control signaling, or via downlink control information. The example method may further comprise: determining, for a second sub-band of the plurality of sub-bands, a second allowable set of precoder matrices; and transmitting, to the user equipment, an indication of the second allowable set of precoder matrices for the second sub-band. The allowable set of precoder matrices for the respective sub-band may be at least partially different from the second allowable set of precoder matrices for the second sub-band. The allowable set of precoder matrices for the respective sub-band may be the same as the second allowable set of precoder matrices for the second sub-band. The allowable set of precoder matrices for the respective sub-band may comprise non-coherent precoder matrices. The allowable set of precoder matrices for the respective sub-band, and allowable sets of precoder matrices respectively associated with sub-bands of the plurality of sub-bands, may comprise sets of precoder matrices that are configured to enable substantially equal usage of a plurality of transmission antennas of the user equipment across a band comprising the plurality of sub-bands.

In accordance with one example embodiment, an apparatus may comprise: circuitry configured to perform: determining, with a network node for a respective sub-band of a plurality of sub-bands configured for uplink transmission with a user equipment, an allowable set of precoder matrices; and circuitry configured to perform: transmitting, to the user equipment, an indication of the allowable set of precoder matrices for the respective sub-band.

In accordance with one example embodiment, an apparatus may comprise: processing circuitry; memory circuitry storing instructions, such as computer readable code, the memory circuitry and the computer readable code configured to, with the processing circuitry, enable the apparatus to: determine, for a respective sub-band of a plurality of sub-bands configured for uplink transmission with a user equipment, an allowable set of precoder matrices; and transmit, to the user equipment, an indication of the allowable set of precoder matrices for the respective sub-band.

In accordance with one example embodiment, an apparatus may comprise means for causing the apparatus to perform at least: determining, for a respective sub-band of a plurality of sub-bands configured for uplink transmission with a user equipment, an allowable set of precoder matrices; and transmitting, to the user equipment, an indication of the allowable set of precoder matrices for the respective sub-band. The means configured for causing the apparatus to perform determining the allowable set of precoder matrices for the respective sub-band may comprise means for causing the apparatus to perform: receiving, from the user equipment, at least one sounding reference signal; and determining the allowable set of precoder matrices for the respective sub-band based, at least partially, on the at least one received sounding reference signal. The means may be further configured for causing the apparatus to perform: transmitting, to the user equipment, a trigger for performing codebook based sounding reference signal transmission. The plurality of sub-bands configured for uplink transmission may comprise a plurality of sub-bands configured for physical uplink shared channel transmission. The indication of the allowable set of precoder matrices for the respective sub-band may be transmitted at least one of: with an allocation of uplink resources, via dedicated signaling, via medium access control signaling, or via downlink control information. The means may be further configured for causing the apparatus to perform: determining a precoder matrix in the allowable set of precoder matrices for the respective sub-band; and transmitting, to the user equipment, an indication of the determined precoder matrix. The precoder matrix in the allowable set of precoder matrices for the respective sub-band may be determined based, at least partially, on at least one received sounding reference signal. The indication of the determined precoder matrix may comprise a transmit precoder matrix index. The indication of the determined precoder matrix may be transmitted at least one of: with an allocation of uplink resources, via dedicated signaling, via medium access control signaling, or via downlink control information. The means may be further configured for causing the apparatus to perform: determining, for a second sub-band of the plurality of sub-bands, a second allowable set of precoder matrices; and transmitting, to the user equipment, an indication of the second allowable set of precoder matrices for the second sub-band. The allowable set of precoder matrices for the respective sub-band may be at least partially different from the second allowable set of precoder matrices for the second sub-band. The allowable set of precoder matrices for the respective sub-band may be the same as the second allowable set of precoder matrices for the second sub-band. The allowable set of precoder matrices for the respective sub-band may comprise non-coherent precoder matrices. The allowable set of precoder matrices for the respective sub-band, and allowable sets of precoder matrices respectively associated with sub-bands of the plurality of sub-bands, may comprise sets of precoder matrices that are configured to enable substantially equal usage of a plurality of transmission antennas of the user equipment across a band comprising the plurality of sub-bands.

In accordance with one example embodiment, a (non-transitory) computer-readable medium comprising instructions stored thereon which, when executed with at least one processor, cause the at least one processor to: determine, with a network node for a respective sub-band of a plurality of sub-bands configured for uplink transmission with a user equipment, of an allowable set of precoder matrices; and cause transmitting, to the user equipment, of an indication of the allowable set of precoder matrices for the respective sub-band.

In accordance with one example embodiment, a (non-transitory) computer-readable medium comprising instructions stored thereon for performing at least the following: determining, with a network node for a respective sub-band of a plurality of sub-bands configured for uplink transmission with a user equipment, of an allowable set of precoder matrices; and causing transmitting, to the user equipment, of an indication of the allowable set of precoder matrices for the respective sub-band. The instructions stored thereon for performing determining the allowable set of precoder matrices for the respective sub-band may comprise instructions for performing: causing receiving, from the user equipment, of at least one sounding reference signal; and determining the allowable set of precoder matrices for the respective sub-band based, at least partially, on the at least one received sounding reference signal. The example computer-readable medium may further comprise instructions stored thereon for performing: causing transmitting, to the user equipment, of a trigger for performing codebook based sounding reference signal transmission. The plurality of sub-bands configured for uplink transmission may comprise a plurality of sub-bands configured for physical uplink shared channel transmission. The indication of the allowable set of precoder matrices for the respective sub-band may be transmitted at least one of: with an allocation of uplink resources, via dedicated signaling, via medium access control signaling, or via downlink control information. The example computer-readable medium may further comprise instructions stored thereon for performing: determining a precoder matrix in the allowable set of precoder matrices for the respective sub-band; and causing transmitting, to the user equipment, of an indication of the determined precoder matrix. The precoder matrix in the allowable set of precoder matrices for the respective sub-band may be determined based, at least partially, on at least one received sounding reference signal. The indication of the determined precoder matrix may comprise a transmit precoder matrix index. The indication of the determined precoder matrix may be transmitted at least one of: with an allocation of uplink resources, via dedicated signaling, via medium access control signaling, or via downlink control information. The example computer-readable medium may further comprise instructions stored thereon for performing: determining, for a second sub-band of the plurality of sub-bands, a second allowable set of precoder matrices; and causing transmitting, to the user equipment, of an indication of the second allowable set of precoder matrices for the second sub-band. The allowable set of precoder matrices for the respective sub-band may be at least partially different from the second allowable set of precoder matrices for the second sub-band. The allowable set of precoder matrices for the respective sub-band may be the same as the second allowable set of precoder matrices for the second sub-band. The allowable set of precoder matrices for the respective sub-band may comprise non-coherent precoder matrices. The allowable set of precoder matrices for the respective sub-band, and allowable sets of precoder matrices respectively associated with sub-bands of the plurality of sub-bands, may comprise sets of precoder matrices that are configured to enable substantially equal usage of a plurality of transmission antennas of the user equipment across a band comprising the plurality of sub-bands.

In accordance with one example embodiment, a (non-transitory) program storage device readable by a machine may be provided, tangibly embodying instructions executable by the machine for performing operations, the operations comprising: determining, with a network node for a respective sub-band of a plurality of sub-bands configured for uplink transmission with a user equipment, of an allowable set of precoder matrices; and causing transmitting, to the user equipment, of an indication of the allowable set of precoder matrices for the respective sub-band.

In accordance with one example embodiment, a (non-transitory) computer-readable medium comprising instructions that, when executed by an apparatus, cause the apparatus to perform at least the following: determining, with a network node for a respective sub-band of a plurality of sub-bands configured for uplink transmission with a user equipment, of an allowable set of precoder matrices; and causing transmitting, to the user equipment, of an indication of the allowable set of precoder matrices for the respective sub-band.

In accordance with one example embodiment, a computer implemented system comprising: at least one processor and at least one (non-transitory) memory storing instructions that, when executed by the at least one processor, cause the system at least to perform: determining, with a network node for a respective sub-band of a plurality of sub-bands configured for uplink transmission with a user equipment, of an allowable set of precoder matrices; and causing transmitting, to the user equipment, of an indication of the allowable set of precoder matrices for the respective sub-band.

In accordance with one example embodiment, a computer implemented system comprising: means for determining, with a network node for a respective sub-band of a plurality of sub-bands configured for uplink transmission with a user equipment, of an allowable set of precoder matrices; and means for causing transmitting, to the user equipment, of an indication of the allowable set of precoder matrices for the respective sub-band.

In accordance with one example embodiment, an apparatus may comprise: at least one processor; and at least one memory storing instructions that, when executed by the at least one processor, cause the apparatus at least to: receive, from a network node, an indication of an ordered set of sub-band precoder matrices, for transmitting at least one uplink transmission using a plurality of sub-bands, wherein the ordered set of sub-band precoder matrices may be comprised in a plurality of configured ordered sets of sub-band precoder matrices; and transmit, to the network node, the at least one uplink transmission based, at least partially, on the indication of the ordered set of sub-band precoder matrices. The ordered set of precoder matrices may comprise a number of precoder matrices equal to a number of sub-bands in the plurality of sub-bands. The plurality of sub-bands may comprise a plurality of sub-bands configured for physical uplink shared channel transmission. The indication of the ordered set of sub-band precoder matrices may comprise an index value associated with the ordered set of sub-band precoder matrices. The indication of the ordered set of sub-band precoder matrices may be received at least one of: with an allocation of uplink resources, via dedicated signaling, via medium access control signaling, or via downlink control information. The example apparatus may be further configured to: receive, from the network node, a trigger for performing codebook based sounding reference signal transmission; and transmit, to the network node, at least one sounding reference signal based, at least partially, on the trigger. The ordered set of sub-band precoder matrices may comprise non-coherent precoder matrices. The plurality of configured ordered sets of sub-band precoder matrices may be respectively configured to enable substantially equal usage of a plurality of transmission antennas of the apparatus across a band comprising the plurality of sub-bands. The ordered set of sub-band precoder matrices may be associated with a transmission rank. The plurality of configured ordered sets of sub-band precoder matrices may be respectively associated with a transmission rank.

In accordance with one example embodiment, an example method may be provided comprising: receiving, with a user equipment from a network node, an indication of an ordered set of sub-band precoder matrices, for transmitting at least one uplink transmission using a plurality of sub-bands, wherein the ordered set of sub-band precoder matrices may be comprised in a plurality of configured ordered sets of sub-band precoder matrices; and transmitting, to the network node, the at least one uplink transmission based, at least partially, on the indication of the ordered set of sub-band precoder matrices. The ordered set of precoder matrices may comprise a number of precoder matrices equal to a number of sub-bands in the plurality of sub-bands. The plurality of sub-bands may comprise a plurality of sub-bands configured for physical uplink shared channel transmission. The indication of the ordered set of sub-band precoder matrices may comprise an index value associated with the ordered set of sub-band precoder matrices. The indication of the ordered set of sub-band precoder matrices may be received at least one of: with an allocation of uplink resources, via dedicated signaling, via medium access control signaling, or via downlink control information. The example method may further comprise: receiving, from the network node, a trigger for performing codebook based sounding reference signal transmission; and transmitting, to the network node, at least one sounding reference signal based, at least partially, on the trigger. The ordered set of sub-band precoder matrices may comprise non-coherent precoder matrices. The plurality of configured ordered sets of sub-band precoder matrices may be respectively configured to enable substantially equal usage of a plurality of transmission antennas of the user equipment across a band comprising the plurality of sub-bands. The ordered set of sub-band precoder matrices may be associated with a transmission rank. The plurality of configured ordered sets of sub-band precoder matrices may be respectively associated with a transmission rank.

In accordance with one example embodiment, an apparatus may comprise: circuitry configured to perform: receiving, with a user equipment from a network node, an indication of an ordered set of sub-band precoder matrices, for transmitting at least one uplink transmission using a plurality of sub-bands, wherein the ordered set of sub-band precoder matrices may be comprised in a plurality of configured ordered sets of sub-band precoder matrices; and circuitry configured to perform: transmitting, to the network node, the at least one uplink transmission based, at least partially, on the indication of the ordered set of sub-band precoder matrices.

In accordance with one example embodiment, an apparatus may comprise: processing circuitry; memory circuitry storing instructions, such as computer readable code, the memory circuitry and the computer readable code configured to, with the processing circuitry, enable the apparatus to: receive, from a network node, an indication of an ordered set of sub-band precoder matrices, for transmitting at least one uplink transmission using a plurality of sub-bands, wherein the ordered set of sub-band precoder matrices may be comprised in a plurality of configured ordered sets of sub-band precoder matrices; and transmit, to the network node, the at least one uplink transmission based, at least partially, on the indication of the ordered set of sub-band precoder matrices.

In accordance with one example embodiment, an apparatus may comprise means for causing the apparatus to perform at least: receiving, from a network node, an indication of an ordered set of sub-band precoder matrices, for transmitting at least one uplink transmission using a plurality of sub-bands, wherein the ordered set of sub-band precoder matrices may be comprised in a plurality of configured ordered sets of sub-band precoder matrices; and transmitting, to the network node, the at least one uplink transmission based, at least partially, on the indication of the ordered set of sub-band precoder matrices. the ordered set of precoder matrices comprises a number of precoder matrices equal to a number of sub-bands in the plurality of sub-bands. The ordered set of precoder matrices may comprise a number of precoder matrices equal to a number of sub-bands in the plurality of sub-bands. The indication of the ordered set of sub-band precoder matrices may comprise an index value associated with the ordered set of sub-band precoder matrices. The indication of the ordered set of sub-band precoder matrices may be received at least one of: with an allocation of uplink resources, via dedicated signaling, via medium access control signaling, or via downlink control information. The means may be further configured for causing the apparatus to perform: receiving, from the network node, a trigger for performing codebook based sounding reference signal transmission; and transmitting, to the network node, at least one sounding reference signal based, at least partially, on the trigger. The ordered set of sub-band precoder matrices may comprise non-coherent precoder matrices. The plurality of configured ordered sets of sub-band precoder matrices may be respectively configured to enable substantially equal usage of a plurality of transmission antennas of the apparatus across a band comprising the plurality of sub-bands. The ordered set of sub-band precoder matrices may be associated with a transmission rank. The plurality of configured ordered sets of sub-band precoder matrices may be respectively associated with a transmission rank.

In accordance with one example embodiment, a (non-transitory) computer-readable medium comprising instructions stored thereon which, when executed with at least one processor, cause the at least one processor to: cause receiving, with a user equipment from a network node, of an indication of an ordered set of sub-band precoder matrices, for transmitting at least one uplink transmission using a plurality of sub-bands, wherein the ordered set of sub-band precoder matrices may be comprised in a plurality of configured ordered sets of sub-band precoder matrices; and cause transmitting, to the network node, of the at least one uplink transmission based, at least partially, on the indication of the ordered set of sub-band precoder matrices.

In accordance with one example embodiment, a (non-transitory) computer-readable medium comprising instructions stored thereon for performing at least the following: causing receiving, with a user equipment from a network node, of an indication of an ordered set of sub-band precoder matrices, for transmitting at least one uplink transmission using a plurality of sub-bands, wherein the ordered set of sub-band precoder matrices may be comprised in a plurality of configured ordered sets of sub-band precoder matrices; and causing transmitting, to the network node, of the at least one uplink transmission based, at least partially, on the indication of the ordered set of sub-band precoder matrices. The ordered set of precoder matrices may comprise a number of precoder matrices equal to a number of sub-bands in the plurality of sub-bands. The plurality of sub-bands may comprise a plurality of sub-bands configured for physical uplink shared channel transmission. The indication of the ordered set of sub-band precoder matrices may comprise an index value associated with the ordered set of sub-band precoder matrices. The indication of the ordered set of sub-band precoder matrices may be received at least one of: with an allocation of uplink resources, via dedicated signaling, via medium access control signaling, or via downlink control information. The example computer-readable medium may further comprise instructions stored thereon for performing: causing receiving, from the network node, of a trigger for performing codebook based sounding reference signal transmission; and causing transmitting, to the network node, of at least one sounding reference signal based, at least partially, on the trigger. The ordered set of sub-band precoder matrices may comprise non-coherent precoder matrices. The plurality of configured ordered sets of sub-band precoder matrices may be respectively configured to enable substantially equal usage of a plurality of transmission antennas of the user equipment across a band comprising the plurality of sub-bands. The ordered set of sub-band precoder matrices may be associated with a transmission rank. The plurality of configured ordered sets of sub-band precoder matrices may be respectively associated with a transmission rank.

In accordance with one example embodiment, a (non-transitory) program storage device readable by a machine may be provided, tangibly embodying instructions executable by the machine for performing operations, the operations comprising: causing receiving, with a user equipment from a network node, of an indication of an ordered set of sub-band precoder matrices, for transmitting at least one uplink transmission using a plurality of sub-bands, wherein the ordered set of sub-band precoder matrices may be comprised in a plurality of configured ordered sets of sub-band precoder matrices; and causing transmitting, to the network node, of the at least one uplink transmission based, at least partially, on the indication of the ordered set of sub-band precoder matrices.

In accordance with one example embodiment, a (non-transitory) computer-readable medium comprising instructions that, when executed by an apparatus, cause the apparatus to perform at least the following: causing receiving, with a user equipment from a network node, of an indication of an ordered set of sub-band precoder matrices, for transmitting at least one uplink transmission using a plurality of sub-bands, wherein the ordered set of sub-band precoder matrices may be comprised in a plurality of configured ordered sets of sub-band precoder matrices; and causing transmitting, to the network node, of the at least one uplink transmission based, at least partially, on the indication of the ordered set of sub-band precoder matrices.

In accordance with one example embodiment, a computer implemented system comprising: at least one processor and at least one (non-transitory) memory storing instructions that, when executed by the at least one processor, cause the system at least to perform: causing receiving, with a user equipment from a network node, of an indication of an ordered set of sub-band precoder matrices, for transmitting at least one uplink transmission using a plurality of sub-bands, wherein the ordered set of sub-band precoder matrices may be comprised in a plurality of configured ordered sets of sub-band precoder matrices; and causing transmitting, to the network node, of the at least one uplink transmission based, at least partially, on the indication of the ordered set of sub-band precoder matrices.

In accordance with one example embodiment, a computer implemented system comprising: means for causing receiving, with a user equipment from a network node, of an indication of an ordered set of sub-band precoder matrices, for transmitting at least one uplink transmission using a plurality of sub-bands, wherein the ordered set of sub-band precoder matrices may be comprised in a plurality of configured ordered sets of sub-band precoder matrices; and means for causing transmitting, to the network node, of the at least one uplink transmission based, at least partially, on the indication of the ordered set of sub-band precoder matrices.

In accordance with one example embodiment, an apparatus may comprise: at least one processor; and at least one memory storing instructions that, when executed by the at least one processor, cause the apparatus at least to: determine, for a plurality of sub-bands configured for uplink transmission with a user equipment, an ordered set of sub-band precoder matrices from a plurality of configured ordered sets of sub-band precoder matrices; and transmit, to the user equipment, an indication of the ordered set of sub-band precoder matrices. determining the ordered set of sub-band precoder matrices may comprise the example apparatus being further configured to: receive, from the user equipment, at least one sounding reference signal; and determine the ordered set of sub-band precoder matrices based, at least partially, on the at least one received sounding reference signal. The example apparatus may be further configured to: transmit, to the user equipment, a trigger for performing codebook based sounding reference signal transmission. The ordered set of precoder matrices may comprise a number of precoder matrices equal to a number of sub-bands in the plurality of sub-bands. The plurality of sub-bands may comprise a plurality of sub-bands configured for physical uplink shared channel transmission. The indication of the ordered set of sub-band precoder matrices may comprise an index value associated with the ordered set of sub-band precoder matrices. The indication of the ordered set of sub-band precoder matrices may be transmitted at least one of: with an allocation of uplink resources, via dedicated signaling, via medium access control signaling, or via downlink control information. The ordered set of sub-band precoder matrices may comprise non-coherent precoder matrices. The plurality of configured ordered sets of sub-band precoder matrices may be respectively configured to enable substantially equal usage of a plurality of transmission antennas of the user equipment across a band comprising the plurality of sub-bands. The ordered set of sub-band precoder matrices may be associated with a transmission rank. The plurality of configured ordered sets of sub-band precoder matrices may be respectively associated with a transmission rank.

In accordance with one example embodiment, an example method may be provided comprising: determining, with a network node for a plurality of sub-bands configured for uplink transmission with a user equipment, an ordered set of sub-band precoder matrices from a plurality of configured ordered sets of sub-band precoder matrices; and transmitting, to the user equipment, an indication of the ordered set of sub-band precoder matrices. The determining of the ordered set of sub-band precoder matrices may comprise: receiving, from the user equipment, at least one sounding reference signal; and determining the ordered set of sub-band precoder matrices based, at least partially, on the at least one received sounding reference signal. The example method may further comprise: transmitting, to the user equipment, a trigger for performing codebook based sounding reference signal transmission. The ordered set of precoder matrices may comprise a number of precoder matrices equal to a number of sub-bands in the plurality of sub-bands. The plurality of sub-bands may comprise a plurality of sub-bands configured for physical uplink shared channel transmission. The indication of the ordered set of sub-band precoder matrices may comprise an index value associated with the ordered set of sub-band precoder matrices. The indication of the ordered set of sub-band precoder matrices may be transmitted at least one of: with an allocation of uplink resources, via dedicated signaling, via medium access control signaling, or via downlink control information. The ordered set of sub-band precoder matrices may comprise non-coherent precoder matrices. The plurality of configured ordered sets of sub-band precoder matrices may be respectively configured to enable substantially equal usage of a plurality of transmission antennas of the user equipment across a band comprising the plurality of sub-bands. The ordered set of sub-band precoder matrices may be associated with a transmission rank. The plurality of configured ordered sets of sub-band precoder matrices may be respectively associated with a transmission rank.

In accordance with one example embodiment, an apparatus may comprise: circuitry configured to perform: determining, with a network node for a plurality of sub-bands configured for uplink transmission with a user equipment, an ordered set of sub-band precoder matrices from a plurality of configured ordered sets of sub-band precoder matrices; and circuitry configured to perform: transmitting, to the user equipment, an indication of the ordered set of sub-band precoder matrices.

In accordance with one example embodiment, an apparatus may comprise: processing circuitry; memory circuitry storing instructions, such as computer readable code, the memory circuitry and the computer readable code configured to, with the processing circuitry, enable the apparatus to: determine, for a plurality of sub-bands configured for uplink transmission with a user equipment, an ordered set of sub-band precoder matrices from a plurality of configured ordered sets of sub-band precoder matrices; and transmit, to the user equipment, an indication of the ordered set of sub-band precoder matrices.

In accordance with one example embodiment, an apparatus may comprise means for causing the apparatus to perform at least: determining, for a plurality of sub-bands configured for uplink transmission with a user equipment, an ordered set of sub-band precoder matrices from a plurality of configured ordered sets of sub-band precoder matrices; and transmitting, to the user equipment, an indication of the ordered set of sub-band precoder matrices. The means configured for causing the apparatus to perform determining the ordered set of sub-band precoder matrices may comprise means for causing the apparatus to perform: receiving, from the user equipment, at least one sounding reference signal; and determining the ordered set of sub-band precoder matrices based, at least partially, on the at least one received sounding reference signal. The means may be further configured for causing the apparatus to perform: transmitting, to the user equipment, a trigger for performing codebook based sounding reference signal transmission. The ordered set of precoder matrices may comprise a number of precoder matrices equal to a number of sub-bands in the plurality of sub-bands. The plurality of sub-bands may comprise a plurality of sub-bands configured for physical uplink shared channel transmission. The indication of the ordered set of sub-band precoder matrices may comprise an index value associated with the ordered set of sub-band precoder matrices. The indication of the ordered set of sub-band precoder matrices may be transmitted at least one of: with an allocation of uplink resources, via dedicated signaling, via medium access control signaling, or via downlink control information. The ordered set of sub-band precoder matrices may comprise non-coherent precoder matrices. The plurality of configured ordered sets of sub-band precoder matrices may be respectively configured to enable substantially equal usage of a plurality of transmission antennas of the user equipment across a band comprising the plurality of sub-bands. The ordered set of sub-band precoder matrices may be associated with a transmission rank. The plurality of configured ordered sets of sub-band precoder matrices may be respectively associated with a transmission rank.

In accordance with one example embodiment, a (non-transitory) computer-readable medium comprising instructions stored thereon which, when executed with at least one processor, cause the at least one processor to: determine, with a network node for a plurality of sub-bands configured for uplink transmission with a user equipment, an ordered set of sub-band precoder matrices from a plurality of configured ordered sets of sub-band precoder matrices; and cause transmitting, to the user equipment, of an indication of the ordered set of sub-band precoder matrices.

In accordance with one example embodiment, a (non-transitory) computer-readable medium comprising instructions stored thereon for performing at least the following: determining, with a network node for a plurality of sub-bands configured for uplink transmission with a user equipment, an ordered set of sub-band precoder matrices from a plurality of configured ordered sets of sub-band precoder matrices; and causing transmitting, to the user equipment, of an indication of the ordered set of sub-band precoder matrices. The instructions stored thereon for performing determining the ordered set of sub-band precoder matrices may comprise instructions for performing: causing receiving, from the user equipment, of at least one sounding reference signal; and determining the ordered set of sub-band precoder matrices based, at least partially, on the at least one received sounding reference signal. The example computer-readable medium may further comprise instructions stored thereon for performing: causing transmitting, to the user equipment, of a trigger for performing codebook based sounding reference signal transmission. The ordered set of precoder matrices may comprise a number of precoder matrices equal to a number of sub-bands in the plurality of sub-bands. The plurality of sub-bands may comprise a plurality of sub-bands configured for physical uplink shared channel transmission. The indication of the ordered set of sub-band precoder matrices may comprise an index value associated with the ordered set of sub-band precoder matrices. The indication of the ordered set of sub-band precoder matrices may be transmitted at least one of: with an allocation of uplink resources, via dedicated signaling, via medium access control signaling, or via downlink control information. The ordered set of sub-band precoder matrices may comprise non-coherent precoder matrices. The plurality of configured ordered sets of sub-band precoder matrices may be respectively configured to enable substantially equal usage of a plurality of transmission antennas of the user equipment across a band comprising the plurality of sub-bands. The ordered set of sub-band precoder matrices may be associated with a transmission rank. The plurality of configured ordered sets of sub-band precoder matrices may be respectively associated with a transmission rank.

In accordance with one example embodiment, a (non-transitory) program storage device readable by a machine may be provided, tangibly embodying instructions executable by the machine for performing operations, the operations comprising: determining, with a network node for a plurality of sub-bands configured for uplink transmission with a user equipment, an ordered set of sub-band precoder matrices from a plurality of configured ordered sets of sub-band precoder matrices; and causing transmitting, to the user equipment, of an indication of the ordered set of sub-band precoder matrices.

In accordance with one example embodiment, a (non-transitory) computer-readable medium comprising instructions that, when executed by an apparatus, cause the apparatus to perform at least the following: determining, with a network node for a plurality of sub-bands configured for uplink transmission with a user equipment, an ordered set of sub-band precoder matrices from a plurality of configured ordered sets of sub-band precoder matrices; and causing transmitting, to the user equipment, of an indication of the ordered set of sub-band precoder matrices.

In accordance with one example embodiment, a computer implemented system comprising: at least one processor and at least one (non-transitory) memory storing instructions that, when executed by the at least one processor, cause the system at least to perform: determining, with a network node for a plurality of sub-bands configured for uplink transmission with a user equipment, an ordered set of sub-band precoder matrices from a plurality of configured ordered sets of sub-band precoder matrices; and causing transmitting, to the user equipment, of an indication of the ordered set of sub-band precoder matrices.

In accordance with one example embodiment, a computer implemented system comprising: means for determining, with a network node for a plurality of sub-bands configured for uplink transmission with a user equipment, an ordered set of sub-band precoder matrices from a plurality of configured ordered sets of sub-band precoder matrices; and means for causing transmitting, to the user equipment, of an indication of the ordered set of sub-band precoder matrices.

In accordance with one example embodiment, an apparatus may comprise: at least one processor; and at least one memory storing instructions that, when executed by the at least one processor, cause the apparatus at least to: receive, from a network node, an indication of two or more ordered sets of sub-band precoder matrices for transmitting at least one uplink transmission using a plurality of sub-bands; determine, for the plurality of sub-bands, an ordered set of sub-band precoder matrices from the two or more ordered sets of sub-band precoder matrices; and transmit, to the network node, the at least one uplink transmission based, at least partially, on the determined ordered set of sub-band precoder matrices. The determined ordered set of sub-band precoder matrices may comprise a number of precoder matrices equal to a number of sub-bands in the plurality of sub-bands. The plurality of sub-bands may comprise a plurality of sub-bands configured for physical uplink shared channel transmission. The indication of the two or more ordered sets of sub-band precoder matrices may comprise at least two index values respectively associated with the two or more ordered sets of sub-band precoder matrices. The indication of the two or more ordered sets of sub-band precoder matrices may be received at least one of: with an allocation of uplink resources, via dedicated signaling, via medium access control signaling, or via downlink control information. The ordered set of sub-band precoder matrices may be determined based, at least partially, on at least one of: transmission power associated with respective ones of the two or more ordered sets of sub-band precoder matrices, a status of at least one transmission antenna associated with the respective ones of the two or more ordered sets of sub-band precoder matrices, a downlink channel between the network node and the apparatus, or at least one downlink channel state information reference signal. Determining the ordered set of sub-band precoder matrices from the two or more ordered sets of sub-band precoder matrices may comprise the example apparatus being further configured to: receive, from the network node, an indication of the ordered set of sub-band precoder matrices within the two or more indicated ordered sets of sub-band precoder matrices. The indication of ordered set of sub-band precoder matrices may comprise an index value associated with the ordered set of sub-band precoder matrices. The indication of ordered set of sub-band precoder matrices may be received at least one of: with an allocation of uplink resources, via dedicated signaling, via medium access control signaling, or via downlink control information. The example apparatus may be further configured to: receive, from the network node, a trigger for performing codebook based sounding reference signal transmission; and transmit, to the network node, at least one sounding reference signal based, at least partially, on the trigger. The determined ordered set of sub-band precoder matrices may comprise non-coherent precoder matrices. The two or more ordered sets of sub-band precoder matrices may be respectively configured to enable substantially equal usage of a plurality of transmission antennas of the apparatus across a band comprising the plurality of sub-bands. The determined ordered set of sub-band precoder matrices may be associated with a transmission rank. The two or more ordered sets of sub-band precoder matrices may be respectively associated with a transmission rank.

In accordance with one example embodiment, an example method may be provided comprising: receiving, with a user equipment from a network node, an indication of two or more ordered sets of sub-band precoder matrices for transmitting at least one uplink transmission using a plurality of sub-bands; determining, for the plurality of sub-bands, an ordered set of sub-band precoder matrices from the two or more ordered sets of sub-band precoder matrices; and transmitting, to the network node, the at least one uplink transmission based, at least partially, on the determined ordered set of sub-band precoder matrices. The determined ordered set of sub-band precoder matrices may comprise a number of precoder matrices equal to a number of sub-bands in the plurality of sub-bands. The plurality of sub-bands may comprise a plurality of sub-bands configured for physical uplink shared channel transmission. The indication of the two or more ordered sets of sub-band precoder matrices may comprise at least two index values respectively associated with the two or more ordered sets of sub-band precoder matrices. The indication of the two or more ordered sets of sub-band precoder matrices may be received at least one of: with an allocation of uplink resources, via dedicated signaling, via medium access control signaling, or via downlink control information. The ordered set of sub-band precoder matrices may be determined based, at least partially, on at least one of: transmission power associated with respective ones of the two or more ordered sets of sub-band precoder matrices, a status of at least one transmission antenna associated with the respective ones of the two or more ordered sets of sub-band precoder matrices, a downlink channel between the network node and the user equipment, or at least one downlink channel state information reference signal. The determining of the ordered set of sub-band precoder matrices from the two or more ordered sets of sub-band precoder matrices may comprise: receiving, from the network node, an indication of the ordered set of sub-band precoder matrices within the two or more indicated ordered sets of sub-band precoder matrices. The indication of ordered set of sub-band precoder matrices may comprise an index value associated with the ordered set of sub-band precoder matrices. The indication of ordered set of sub-band precoder matrices may be received at least one of: with an allocation of uplink resources, via dedicated signaling, via medium access control signaling, or via downlink control information. The example method may further comprise: receiving, from the network node, a trigger for performing codebook based sounding reference signal transmission; and transmitting, to the network node, at least one sounding reference signal based, at least partially, on the trigger. The determined ordered set of sub-band precoder matrices may comprise non-coherent precoder matrices. The two or more ordered sets of sub-band precoder matrices may be respectively configured to enable substantially equal usage of a plurality of transmission antennas of the user equipment across a band comprising the plurality of sub-bands. The determined ordered set of sub-band precoder matrices may be associated with a transmission rank. The two or more ordered sets of sub-band precoder matrices may be respectively associated with a transmission rank.

In accordance with one example embodiment, an apparatus may comprise: circuitry configured to perform: receiving, with a user equipment from a network node, an indication of two or more ordered sets of sub-band precoder matrices for transmitting at least one uplink transmission using a plurality of sub-bands; circuitry configured to perform: determining, for the plurality of sub-bands, an ordered set of sub-band precoder matrices from the two or more ordered sets of sub-band precoder matrices; and circuitry configured to perform: transmitting, to the network node, the at least one uplink transmission based, at least partially, on the determined ordered set of sub-band precoder matrices.

In accordance with one example embodiment, an apparatus may comprise: processing circuitry; memory circuitry storing instructions, such as computer readable code, the memory circuitry and the computer readable code configured to, with the processing circuitry, enable the apparatus to: receive, from a network node, an indication of two or more ordered sets of sub-band precoder matrices for transmitting at least one uplink transmission using a plurality of sub-bands; determine, for the plurality of sub-bands, an ordered set of sub-band precoder matrices from the two or more ordered sets of sub-band precoder matrices; and transmit, to the network node, the at least one uplink transmission based, at least partially, on the determined ordered set of sub-band precoder matrices.

In accordance with one example embodiment, an apparatus may comprise means for causing the apparatus to perform at least: receiving, from a network node, an indication of two or more ordered sets of sub-band precoder matrices for transmitting at least one uplink transmission using a plurality of sub-bands; determining, for the plurality of sub-bands, an ordered set of sub-band precoder matrices from the two or more ordered sets of sub-band precoder matrices; and transmitting, to the network node, the at least one uplink transmission based, at least partially, on the determined ordered set of sub-band precoder matrices. The determined ordered set of sub-band precoder matrices may comprise a number of precoder matrices equal to a number of sub-bands in the plurality of sub-bands. The plurality of sub-bands may comprise a plurality of sub-bands configured for physical uplink shared channel transmission. The indication of the two or more ordered sets of sub-band precoder matrices may comprise at least two index values respectively associated with the two or more ordered sets of sub-band precoder matrices. The indication of the two or more ordered sets of sub-band precoder matrices may be received at least one of: with an allocation of uplink resources, via dedicated signaling, via medium access control signaling, or via downlink control information. The ordered set of sub-band precoder matrices may be determined based, at least partially, on at least one of: transmission power associated with respective ones of the two or more ordered sets of sub-band precoder matrices, a status of at least one transmission antenna associated with the respective ones of the two or more ordered sets of sub-band precoder matrices, a downlink channel between the network node and the apparatus, or at least one downlink channel state information reference signal. The means configured for causing the apparatus to perform determining the ordered set of sub-band precoder matrices from the two or more ordered sets of sub-band precoder matrices may comprise means for causing the apparatus to perform: receiving, from the network node, an indication of the ordered set of sub-band precoder matrices within the two or more indicated ordered sets of sub-band precoder matrices. The indication of ordered set of sub-band precoder matrices may comprise an index value associated with the ordered set of sub-band precoder matrices. The indication of ordered set of sub-band precoder matrices may be received at least one of: with an allocation of uplink resources, via dedicated signaling, via medium access control signaling, or via downlink control information. The means may be further configured for causing the apparatus to perform: receiving, from the network node, a trigger for performing codebook based sounding reference signal transmission; and transmitting, to the network node, at least one sounding reference signal based, at least partially, on the trigger. The determined ordered set of sub-band precoder matrices may comprise non-coherent precoder matrices. The two or more ordered sets of sub-band precoder matrices may be respectively configured to enable substantially equal usage of a plurality of transmission antennas of the apparatus across a band comprising the plurality of sub-bands. The determined ordered set of sub-band precoder matrices may be associated with a transmission rank. The two or more ordered sets of sub-band precoder matrices may be respectively associated with a transmission rank.

In accordance with one example embodiment, a (non-transitory) computer-readable medium comprising instructions stored thereon which, when executed with at least one processor, cause the at least one processor to: cause receiving, with a user equipment from a network node, of an indication of two or more ordered sets of sub-band precoder matrices for transmitting at least one uplink transmission using a plurality of sub-bands; determine, for the plurality of sub-bands, an ordered set of sub-band precoder matrices from the two or more ordered sets of sub-band precoder matrices; and cause transmitting, to the network node, of the at least one uplink transmission based, at least partially, on the determined ordered set of sub-band precoder matrices.

In accordance with one example embodiment, a (non-transitory) computer-readable medium comprising instructions stored thereon for performing at least the following: causing receiving, with a user equipment from a network node, of an indication of two or more ordered sets of sub-band precoder matrices for transmitting at least one uplink transmission using a plurality of sub-bands; determining, for the plurality of sub-bands, an ordered set of sub-band precoder matrices from the two or more ordered sets of sub-band precoder matrices; and causing transmitting, to the network node, of the at least one uplink transmission based, at least partially, on the determined ordered set of sub-band precoder matrices. The determined ordered set of sub-band precoder matrices may comprise a number of precoder matrices equal to a number of sub-bands in the plurality of sub-bands. The plurality of sub-bands may comprise a plurality of sub-bands configured for physical uplink shared channel transmission. The indication of the two or more ordered sets of sub-band precoder matrices may comprise at least two index values respectively associated with the two or more ordered sets of sub-band precoder matrices. The indication of the two or more ordered sets of sub-band precoder matrices may be received at least one of: with an allocation of uplink resources, via dedicated signaling, via medium access control signaling, or via downlink control information. The ordered set of sub-band precoder matrices may be determined based, at least partially, on at least one of: transmission power associated with respective ones of the two or more ordered sets of sub-band precoder matrices, a status of at least one transmission antenna associated with the respective ones of the two or more ordered sets of sub-band precoder matrices, a downlink channel between the network node and the user equipment, or at least one downlink channel state information reference signal. The instructions stored thereon for performing determining the ordered set of sub-band precoder matrices from the two or more ordered sets of sub-band precoder matrices may comprise instructions for performing: causing receiving, from the network node, of an indication of the ordered set of sub-band precoder matrices within the two or more indicated ordered sets of sub-band precoder matrices. The indication of ordered set of sub-band precoder matrices may comprise an index value associated with the ordered set of sub-band precoder matrices. The indication of ordered set of sub-band precoder matrices may be received at least one of: with an allocation of uplink resources, via dedicated signaling, via medium access control signaling, or via downlink control information. The example computer-readable medium may further comprise instructions stored thereon for performing: causing receiving, from the network node, of a trigger for performing codebook based sounding reference signal transmission; and causing transmitting, to the network node, of at least one sounding reference signal based, at least partially, on the trigger. The determined ordered set of sub-band precoder matrices may comprise non-coherent precoder matrices. The two or more ordered sets of sub-band precoder matrices may be respectively configured to enable substantially equal usage of a plurality of transmission antennas of the user equipment across a band comprising the plurality of sub-bands. The determined ordered set of sub-band precoder matrices may be associated with a transmission rank. The two or more ordered sets of sub-band precoder matrices may be respectively associated with a transmission rank.

In accordance with one example embodiment, a (non-transitory) program storage device readable by a machine may be provided, tangibly embodying instructions executable by the machine for performing operations, the operations comprising: causing receiving, with a user equipment from a network node, of an indication of two or more ordered sets of sub-band precoder matrices for transmitting at least one uplink transmission using a plurality of sub-bands; determining, for the plurality of sub-bands, an ordered set of sub-band precoder matrices from the two or more ordered sets of sub-band precoder matrices; and causing transmitting, to the network node, of the at least one uplink transmission based, at least partially, on the determined ordered set of sub-band precoder matrices.

In accordance with one example embodiment, a (non-transitory) computer-readable medium comprising instructions that, when executed by an apparatus, cause the apparatus to perform at least the following: causing receiving, with a user equipment from a network node, of an indication of two or more ordered sets of sub-band precoder matrices for transmitting at least one uplink transmission using a plurality of sub-bands; determining, for the plurality of sub-bands, an ordered set of sub-band precoder matrices from the two or more ordered sets of sub-band precoder matrices; and causing transmitting, to the network node, of the at least one uplink transmission based, at least partially, on the determined ordered set of sub-band precoder matrices.

In accordance with one example embodiment, a computer implemented system comprising: at least one processor and at least one (non-transitory) memory storing instructions that, when executed by the at least one processor, cause the system at least to perform: causing receiving, with a user equipment from a network node, of an indication of two or more ordered sets of sub-band precoder matrices for transmitting at least one uplink transmission using a plurality of sub-bands; determining, for the plurality of sub-bands, an ordered set of sub-band precoder matrices from the two or more ordered sets of sub-band precoder matrices; and causing transmitting, to the network node, of the at least one uplink transmission based, at least partially, on the determined ordered set of sub-band precoder matrices.

In accordance with one example embodiment, a computer implemented system comprising: means for causing receiving, with a user equipment from a network node, of an indication of two or more ordered sets of sub-band precoder matrices for transmitting at least one uplink transmission using a plurality of sub-bands; means for determining, for the plurality of sub-bands, an ordered set of sub-band precoder matrices from the two or more ordered sets of sub-band precoder matrices; and means for causing transmitting, to the network node, of the at least one uplink transmission based, at least partially, on the determined ordered set of sub-band precoder matrices.

In accordance with one example embodiment, an apparatus may comprise: at least one processor; and at least one memory storing instructions that, when executed by the at least one processor, cause the apparatus at least to: determine, for a plurality of sub-bands configured for uplink transmission with a user equipment, two or more ordered sets of sub-band precoder matrices; and transmit, to the user equipment, an indication of the two or more ordered sets of sub-band precoder matrices. Determining the two or more ordered sets of sub-band precoder matrices may comprise the example apparatus being further configured to: receive, from the user equipment, at least one sounding reference signal; and determine the two or more ordered sets of sub-band precoder matrices for the plurality of sub-bands based, at least partially, on the at least one received sounding reference signal. The example apparatus may be further configured to: transmit, to the user equipment, a trigger for performing codebook based sounding reference signal transmission. Respective ones of the two or more ordered sets of sub-band precoder matrices may comprise a number of precoder matrices equal to a number of sub-bands in the plurality of sub-bands. The plurality of sub-bands may comprise a plurality of sub-bands configured for physical uplink shared channel transmission. The indication of the two or more ordered sets of sub-band precoder matrices may comprise at least two index values respectively associated with the two or more ordered sets of sub-band precoder matrices. The indication of the two or more determined ordered sets of sub-band precoder matrices may be transmitted at least one of: with an allocation of uplink resources, via dedicated signaling, via medium access control signaling, or via downlink control information. The example apparatus may be further configured to: determine an ordered set of sub-band precoder matrices within the two or more indicated ordered sets of sub-band precoder matrices for the plurality of sub-bands; and transmit, to the user equipment, an indication of the determined ordered set of sub-band precoder matrices. The indication of the determined ordered set of sub-band precoder matrices may comprise an index value associated with the determined ordered set of sub-band precoder matrices. The indication of the determined ordered set of sub-band precoder matrices may be transmitted at least one of: with an allocation of uplink resources, via dedicated signaling, via medium access control signaling, or via downlink control information. The two or more ordered sets of sub-band precoder matrices may comprise non-coherent precoder matrices. The two or more ordered sets of sub-band precoder matrices may be respectively configured to enable substantially equal usage of a plurality of transmission antennas of the user equipment across a band comprising the plurality of sub-bands. The two or more ordered sets of sub-band precoder matrices may be respectively associated with a transmission rank.

In accordance with one example embodiment, an example method may be provided comprising: determining, with a network node for a plurality of sub-bands configured for uplink transmission with a user equipment, two or more ordered sets of sub-band precoder matrices; and transmitting, to the user equipment, an indication of the two or more ordered sets of sub-band precoder matrices. The determining of the two or more ordered sets of sub-band precoder matrices may comprise: receiving, from the user equipment, at least one sounding reference signal; and determining the two or more ordered sets of sub-band precoder matrices for the plurality of sub-bands based, at least partially, on the at least one received sounding reference signal. The example method may further comprise: transmitting, to the user equipment, a trigger for performing codebook based sounding reference signal transmission. Respective ones of the two or more ordered sets of sub-band precoder matrices may comprise a number of precoder matrices equal to a number of sub-bands in the plurality of sub-bands. The plurality of sub-bands may comprise a plurality of sub-bands configured for physical uplink shared channel transmission. The indication of the two or more ordered sets of sub-band precoder matrices may comprise at least two index values respectively associated with the two or more ordered sets of sub-band precoder matrices. The indication of the two or more determined ordered sets of sub-band precoder matrices may be transmitted at least one of: with an allocation of uplink resources, via dedicated signaling, via medium access control signaling, or via downlink control information. The example method may further comprise: determining an ordered set of sub-band precoder matrices within the two or more indicated ordered sets of sub-band precoder matrices for the plurality of sub-bands; and transmitting, to the user equipment, an indication of the determined ordered set of sub-band precoder matrices. The indication of the determined ordered set of sub-band precoder matrices may comprise an index value associated with the determined ordered set of sub-band precoder matrices. The indication of the determined ordered set of sub-band precoder matrices may be transmitted at least one of: with an allocation of uplink resources, via dedicated signaling, via medium access control signaling, or via downlink control information. The two or more ordered sets of sub-band precoder matrices may comprise non-coherent precoder matrices. The two or more ordered sets of sub-band precoder matrices may be respectively configured to enable substantially equal usage of a plurality of transmission antennas of the user equipment across a band comprising the plurality of sub-bands. The two or more ordered sets of sub-band precoder matrices may be respectively associated with a transmission rank.

In accordance with one example embodiment, an apparatus may comprise: circuitry configured to perform: determining, with a network node for a plurality of sub-bands configured for uplink transmission with a user equipment, two or more ordered sets of sub-band precoder matrices; and circuitry configured to perform: transmitting, to the user equipment, an indication of the two or more ordered sets of sub-band precoder matrices.

In accordance with one example embodiment, an apparatus may comprise: processing circuitry; memory circuitry storing instructions, such as computer readable code, the memory circuitry and the computer readable code configured to, with the processing circuitry, enable the apparatus to: determine, for a plurality of sub-bands configured for uplink transmission with a user equipment, two or more ordered sets of sub-band precoder matrices; and transmit, to the user equipment, an indication of the two or more ordered sets of sub-band precoder matrices.

In accordance with one example embodiment, an apparatus may comprise means for causing the apparatus to perform at least: determining, for a plurality of sub-bands configured for uplink transmission with a user equipment, two or more ordered sets of sub-band precoder matrices; and transmitting, to the user equipment, an indication of the two or more ordered sets of sub-band precoder matrices. The means configured for causing the apparatus to perform determining the two or more ordered sets of sub-band precoder matrices may comprise means for causing the apparatus to perform: receiving, from the user equipment, at least one sounding reference signal; and determining the two or more ordered sets of sub-band precoder matrices for the plurality of sub-bands based, at least partially, on the at least one received sounding reference signal. The means may be further configured for causing the apparatus to perform: transmitting, to the user equipment, a trigger for performing codebook based sounding reference signal transmission. Respective ones of the two or more ordered sets of sub-band precoder matrices may comprise a number of precoder matrices equal to a number of sub-bands in the plurality of sub-bands. The plurality of sub-bands may comprise a plurality of sub-bands configured for physical uplink shared channel transmission. The indication of the two or more ordered sets of sub-band precoder matrices may comprise at least two index values respectively associated with the two or more ordered sets of sub-band precoder matrices. The indication of the two or more determined ordered sets of sub-band precoder matrices may be transmitted at least one of: with an allocation of uplink resources, via dedicated signaling, via medium access control signaling, or via downlink control information. The means may be further configured for causing the apparatus to perform: determining an ordered set of sub-band precoder matrices within the two or more indicated ordered sets of sub-band precoder matrices for the plurality of sub-bands; and transmitting, to the user equipment, an indication of the determined ordered set of sub-band precoder matrices. The indication of the determined ordered set of sub-band precoder matrices may comprise an index value associated with the determined ordered set of sub-band precoder matrices. The indication of the determined ordered set of sub-band precoder matrices may be transmitted at least one of: with an allocation of uplink resources, via dedicated signaling, via medium access control signaling, or via downlink control information. The two or more ordered sets of sub-band precoder matrices may comprise non-coherent precoder matrices. The two or more ordered sets of sub-band precoder matrices may be respectively configured to enable substantially equal usage of a plurality of transmission antennas of the user equipment across a band comprising the plurality of sub-bands. The two or more ordered sets of sub-band precoder matrices may be respectively associated with a transmission rank.

In accordance with one example embodiment, a (non-transitory) computer-readable medium comprising instructions stored thereon which, when executed with at least one processor, cause the at least one processor to: determine, with a network node for a plurality of sub-bands configured for uplink transmission with a user equipment, two or more ordered sets of sub-band precoder matrices; and cause transmitting, to the user equipment, of an indication of the two or more ordered sets of sub-band precoder matrices.

In accordance with one example embodiment, a (non-transitory) computer-readable medium comprising instructions stored thereon for performing at least the following: determining, with a network node for a plurality of sub-bands configured for uplink transmission with a user equipment, two or more ordered sets of sub-band precoder matrices; and causing transmitting, to the user equipment, of an indication of the two or more ordered sets of sub-band precoder matrices. instructions stored thereon for performing determining the two or more ordered sets of sub-band precoder matrices may comprise instructions for performing: causing receiving, from the user equipment, of at least one sounding reference signal; and determining the two or more ordered sets of sub-band precoder matrices for the plurality of sub-bands based, at least partially, on the at least one received sounding reference signal. The example computer-readable medium may further comprise instructions stored thereon for performing: causing transmitting, to the user equipment, of a trigger for performing codebook based sounding reference signal transmission. Respective ones of the two or more ordered sets of sub-band precoder matrices may comprise a number of precoder matrices equal to a number of sub-bands in the plurality of sub-bands. The plurality of sub-bands may comprise a plurality of sub-bands configured for physical uplink shared channel transmission. The indication of the two or more ordered sets of sub-band precoder matrices may comprise at least two index values respectively associated with the two or more ordered sets of sub-band precoder matrices. The indication of the two or more determined ordered sets of sub-band precoder matrices may be transmitted at least one of: with an allocation of uplink resources, via dedicated signaling, via medium access control signaling, or via downlink control information. The example computer-readable medium may further comprise instructions stored thereon for performing: determining an ordered set of sub-band precoder matrices within the two or more indicated ordered sets of sub-band precoder matrices for the plurality of sub-bands; and causing transmitting, to the user equipment, of an indication of the determined ordered set of sub-band precoder matrices. The indication of the determined ordered set of sub-band precoder matrices may comprise an index value associated with the determined ordered set of sub-band precoder matrices. The indication of the determined ordered set of sub-band precoder matrices may be transmitted at least one of: with an allocation of uplink resources, via dedicated signaling, via medium access control signaling, or via downlink control information. The two or more ordered sets of sub-band precoder matrices may comprise non-coherent precoder matrices. The two or more ordered sets of sub-band precoder matrices may be respectively configured to enable substantially equal usage of a plurality of transmission antennas of the user equipment across a band comprising the plurality of sub-bands. The two or more ordered sets of sub-band precoder matrices may be respectively associated with a transmission rank.

In accordance with one example embodiment, a (non-transitory) program storage device readable by a machine may be provided, tangibly embodying instructions executable by the machine for performing operations, the operations comprising: determining, with a network node for a plurality of sub-bands configured for uplink transmission with a user equipment, two or more ordered sets of sub-band precoder matrices; and causing transmitting, to the user equipment, of an indication of the two or more ordered sets of sub-band precoder matrices.

In accordance with one example embodiment, a (non-transitory) computer-readable medium comprising instructions that, when executed by an apparatus, cause the apparatus to perform at least the following: determining, with a network node for a plurality of sub-bands configured for uplink transmission with a user equipment, two or more ordered sets of sub-band precoder matrices; and causing transmitting, to the user equipment, of an indication of the two or more ordered sets of sub-band precoder matrices.

In accordance with one example embodiment, a computer implemented system comprising: at least one processor and at least one (non-transitory) memory storing instructions that, when executed by the at least one processor, cause the system at least to perform: determining, with a network node for a plurality of sub-bands configured for uplink transmission with a user equipment, two or more ordered sets of sub-band precoder matrices; and causing transmitting, to the user equipment, of an indication of the two or more ordered sets of sub-band precoder matrices.

In accordance with one example embodiment, a computer implemented system comprising: means for determining, with a network node for a plurality of sub-bands configured for uplink transmission with a user equipment, two or more ordered sets of sub-band precoder matrices; and means for causing transmitting, to the user equipment, of an indication of the two or more ordered sets of sub-band precoder matrices.

In accordance with one example embodiment, an apparatus may comprise: at least one processor; and at least one memory storing instructions that, when executed by the at least one processor, cause the apparatus at least to: receive, from a network node, at least one channel state information reference signal; estimate a downlink channel based, at least partially, on the at least one channel state information reference signal; estimate an uplink channel based, at least partially, on the estimated downlink channel; determine a rank indicator and at least one precoder matrix based, at least partially, on the estimated uplink channel, wherein the at least one precoder matrix may comprise at least one of: a precoder matrix comprised in one of: a set of precoder matrices configured for a sub-band of a plurality of sub-bands configured for uplink transmission, or a set of precoder matrices indicated, by the network node, for the sub-band of the plurality of sub-bands, or an ordered set of sub-band precoder matrices comprised in one of: a plurality of configured ordered sets of sub-band precoder matrices, or a plurality of ordered sets of sub-band precoder matrices indicated by the network node; and transmit, to the network node using the plurality of sub-bands, at least one uplink transmission based, at least partially, on the determined rank indicator and the at least one determined precoder matrix.

The example apparatus may be further configured to: transmit, to the network node, an indication of the determined rank indicator. Determining the rank indicator and the at least one precoder matrix may comprise the example apparatus being further configured to: determine, for respective rank indicators of a plurality of rank indicators with respect to respective sub-bands of the plurality of sub-bands, a precoder matrix estimated to provide a highest spectral efficiency based, at least partially, on the estimated uplink channel, wherein the precoder matrix may be comprised in one of: a set of precoder matrices configured for the respective sub-band, or a set of precoder matrices indicated, by the network node, for the respective sub-band; determine, for the respective rank indicators, an estimated spectral efficiency across the plurality of sub-bands produced using, for the respective sub-bands of the plurality of sub-bands, the precoder matrix estimated to provide the highest spectral efficiency; determine the rank indicator, of the plurality of rank indicators, with a highest estimated spectral efficiency across the plurality of sub-bands; and determine, using the determined rank indicator with the highest estimated spectral efficiency across the plurality of sub-bands, a respective precoder matrix for the respective sub-bands of the plurality of sub-bands. Determining the rank indicator and the at least one precoder matrix may comprise the example apparatus being further configured to: receive, from the network node, an indication of the rank indicator; and determine, for the rank indicator with respect to respective sub-bands of the plurality of sub-bands, a precoder matrix estimated to provide a highest spectral efficiency based, at least partially, on the estimated uplink channel, wherein the precoder matrix may be comprised in one of: the set of precoder matrices configured for the respective sub-band, or the set of precoder matrices indicated, by the network node, for the respective sub-band. The apparatus may be configured with a codebook comprising the set of precoder matrices configured the sub-band of the plurality of sub-bands. The example apparatus may be further configured to: receive, from the network node, an indication of the set of precoder matrices for the sub-band of the plurality of sub-bands. Determining the rank indicator and the at least one precoder matrix may comprise the example apparatus being further configured to: determine, for respective rank indicators of a plurality of rank indicators with respect to the plurality of sub-bands, a spectral efficiency, based, at least partially, on the estimated uplink channel, across the plurality of sub-bands provided using respective ordered sets of sub-band precoder matrices comprised in one of: the plurality of configured ordered sets of sub-band precoder matrices, or the plurality of ordered sets of sub-band precoder matrices indicated by the network node; determine the rank indicator, of the plurality of rank indicators, with a highest estimated spectral efficiency across the plurality of sub-bands; and determine, using the determined rank indicator with the highest estimated spectral efficiency across the plurality of sub-bands, the ordered set of sub-band precoder matrices. Determining the rank indicator and the at least one precoder matrix may comprise the example apparatus being further configured to: receive, from the network node, an indication of the rank indicator; and determine, for the rank indicator with respect to the plurality of sub-bands, an ordered set of sub-band precoder matrices estimated to provide a highest spectral efficiency based, at least partially, on the estimated uplink channel, wherein the ordered set of sub-band precoder matrices may be comprised in one of: the plurality of configured ordered sets of sub-band precoder matrices, or the plurality of ordered sets of sub-band precoder matrices indicated by the network node. The apparatus may be configured with a codebook comprising the plurality of configured ordered sets of sub-band precoder matrices. The example apparatus may be further configured to: receive, from the network node, an indication of the plurality of ordered sets of sub-band precoder matrices. The uplink channel may be estimated based on a transpose of a downlink channel matrix representing the estimated downlink channel.

In accordance with one example embodiment, an example method may be provided comprising: receiving, with a user equipment from a network node, at least one channel state information reference signal; estimating a downlink channel based, at least partially, on the at least one channel state information reference signal; estimating an uplink channel based, at least partially, on the estimated downlink channel; determining a rank indicator and at least one precoder matrix based, at least partially, on the estimated uplink channel, wherein the at least one precoder matrix may comprise at least one of: a precoder matrix comprised in one of: a set of precoder matrices configured for a sub-band of a plurality of sub-bands configured for uplink transmission, or a set of precoder matrices indicated, by the network node, for the sub-band of the plurality of sub-bands, or an ordered set of sub-band precoder matrices comprised in one of: a plurality of configured ordered sets of sub-band precoder matrices, or a plurality of ordered sets of sub-band precoder matrices indicated by the network node; and transmitting, to the network node using the plurality of sub-bands, at least one uplink transmission based, at least partially, on the determined rank indicator and the at least one determined precoder matrix.

The example method may further comprise: transmitting, to the network node, an indication of the determined rank indicator. The determining of the rank indicator and the at least one precoder matrix may comprise: determining, for respective rank indicators of a plurality of rank indicators with respect to respective sub-bands of the plurality of sub-bands, a precoder matrix estimated to provide a highest spectral efficiency based, at least partially, on the estimated uplink channel, wherein the precoder matrix may be comprised in one of: a set of precoder matrices configured for the respective sub-band, or a set of precoder matrices indicated, by the network node, for the respective sub-band; determining, for the respective rank indicators, an estimated spectral efficiency across the plurality of sub-bands produced using, for the respective sub-bands of the plurality of sub-bands, the precoder matrix estimated to provide the highest spectral efficiency; determining the rank indicator, of the plurality of rank indicators, with a highest estimated spectral efficiency across the plurality of sub-bands; and determining, using the determined rank indicator with the highest estimated spectral efficiency across the plurality of sub-bands, a respective precoder matrix for the respective sub-bands of the plurality of sub-bands. The determining of the rank indicator and the at least one precoder matrix may comprise: receiving, from the network node, an indication of the rank indicator; and determining, for the rank indicator with respect to respective sub-bands of the plurality of sub-bands, a precoder matrix estimated to provide a highest spectral efficiency based, at least partially, on the estimated uplink channel, wherein the precoder matrix may be comprised in one of: the set of precoder matrices configured for the respective sub-band, or the set of precoder matrices indicated, by the network node, for the respective sub-band. The user equipment may be configured with a codebook comprising the set of precoder matrices configured the sub-band of the plurality of sub-bands. The example method may further comprise: receiving, from the network node, an indication of the set of precoder matrices for the sub-band of the plurality of sub-bands. The determining of the rank indicator and the at least one precoder matrix may comprise: determining, for respective rank indicators of a plurality of rank indicators with respect to the plurality of sub-bands, a spectral efficiency, based, at least partially, on the estimated uplink channel, across the plurality of sub-bands provided using respective ordered sets of sub-band precoder matrices comprised in one of: the plurality of configured ordered sets of sub-band precoder matrices, or the plurality of ordered sets of sub-band precoder matrices indicated by the network node; determining the rank indicator, of the plurality of rank indicators, with a highest estimated spectral efficiency across the plurality of sub-bands; and determining, using the determined rank indicator with the highest estimated spectral efficiency across the plurality of sub-bands, the ordered set of sub-band precoder matrices. The determining of the rank indicator and the at least one precoder matrix may comprise: receiving, from the network node, an indication of the rank indicator; and determining, for the rank indicator with respect to the plurality of sub-bands, an ordered set of sub-band precoder matrices estimated to provide a highest spectral efficiency based, at least partially, on the estimated uplink channel, wherein the ordered set of sub-band precoder matrices may be comprised in one of: the plurality of configured ordered sets of sub-band precoder matrices, or the plurality of ordered sets of sub-band precoder matrices indicated by the network node. The user equipment may be configured with a codebook comprising the plurality of configured ordered sets of sub-band precoder matrices. The example method may further comprise: receiving, from the network node, an indication of the plurality of ordered sets of sub-band precoder matrices. The uplink channel may be estimated based on a transpose of a downlink channel matrix representing the estimated downlink channel.

In accordance with one example embodiment, an apparatus may comprise: circuitry configured to perform: receiving, with a user equipment from a network node, at least one channel state information reference signal; circuitry configured to perform: estimating a downlink channel based, at least partially, on the at least one channel state information reference signal; circuitry configured to perform: estimating an uplink channel based, at least partially, on the estimated downlink channel; circuitry configured to perform: determining a rank indicator and at least one precoder matrix based, at least partially, on the estimated uplink channel, wherein the at least one precoder matrix may comprise at least one of: a precoder matrix comprised in one of: a set of precoder matrices configured for a sub-band of a plurality of sub-bands configured for uplink transmission, or a set of precoder matrices indicated, by the network node, for the sub-band of the plurality of sub-bands, or an ordered set of sub-band precoder matrices comprised in one of: a plurality of configured ordered sets of sub-band precoder matrices, or a plurality of ordered sets of sub-band precoder matrices indicated by the network node; and circuitry configured to perform: transmitting, to the network node using the plurality of sub-bands, at least one uplink transmission based, at least partially, on the determined rank indicator and the at least one determined precoder matrix.

In accordance with one example embodiment, an apparatus may comprise: processing circuitry; memory circuitry storing instructions, such as computer readable code, the memory circuitry and the computer readable code configured to, with the processing circuitry, enable the apparatus to: receive, from a network node, at least one channel state information reference signal; estimate a downlink channel based, at least partially, on the at least one channel state information reference signal; estimate an uplink channel based, at least partially, on the estimated downlink channel; determine a rank indicator and at least one precoder matrix based, at least partially, on the estimated uplink channel, wherein the at least one precoder matrix may comprise at least one of: a precoder matrix comprised in one of: a set of precoder matrices configured for a sub-band of a plurality of sub-bands configured for uplink transmission, or a set of precoder matrices indicated, by the network node, for the sub-band of the plurality of sub-bands, or an ordered set of sub-band precoder matrices comprised in one of: a plurality of configured ordered sets of sub-band precoder matrices, or a plurality of ordered sets of sub-band precoder matrices indicated by the network node; and transmit, to the network node using the plurality of sub-bands, at least one uplink transmission based, at least partially, on the determined rank indicator and the at least one determined precoder matrix.

In accordance with one example embodiment, an apparatus may comprise means for causing the apparatus to perform at least: receiving, from a network node, at least one channel state information reference signal; estimating a downlink channel based, at least partially, on the at least one channel state information reference signal; estimating an uplink channel based, at least partially, on the estimated downlink channel; determining a rank indicator and at least one precoder matrix based, at least partially, on the estimated uplink channel, wherein the at least one precoder matrix may comprise at least one of: a precoder matrix comprised in one of: a set of precoder matrices configured for a sub-band of a plurality of sub-bands configured for uplink transmission, or a set of precoder matrices indicated, by the network node, for the sub-band of the plurality of sub-bands, or an ordered set of sub-band precoder matrices comprised in one of: a plurality of configured ordered sets of sub-band precoder matrices, or a plurality of ordered sets of sub-band precoder matrices indicated by the network node; and transmitting, to the network node using the plurality of sub-bands, at least one uplink transmission based, at least partially, on the determined rank indicator and the at least one determined precoder matrix. The means may be further configured for causing the apparatus to perform: transmitting, to the network node, an indication of the determined rank indicator. The means configured for causing the apparatus to perform determining the rank indicator and the at least one precoder matrix may comprise means for causing the apparatus to perform: determining, for respective rank indicators of a plurality of rank indicators with respect to respective sub-bands of the plurality of sub-bands, a precoder matrix estimated to provide a highest spectral efficiency based, at least partially, on the estimated uplink channel, wherein the precoder matrix is comprised in one of: a set of precoder matrices configured for the respective sub-band, or a set of precoder matrices indicated, by the network node, for the respective sub-band; determining, for the respective rank indicators, an estimated spectral efficiency across the plurality of sub-bands produced using, for the respective sub-bands of the plurality of sub-bands, the precoder matrix estimated to provide the highest spectral efficiency; determining the rank indicator, of the plurality of rank indicators, with a highest estimated spectral efficiency across the plurality of sub-bands; and determining, using the determined rank indicator with the highest estimated spectral efficiency across the plurality of sub-bands, a respective precoder matrix for the respective sub-bands of the plurality of sub-bands. The means configured for causing the apparatus to perform determining the rank indicator and the at least one precoder matrix may comprise means for causing the apparatus to perform: receiving, from the network node, an indication of the rank indicator; and determining, for the rank indicator with respect to respective sub-bands of the plurality of sub-bands, a precoder matrix estimated to provide a highest spectral efficiency based, at least partially, on the estimated uplink channel, wherein the precoder matrix may be comprised in one of: the set of precoder matrices configured for the respective sub-band, or the set of precoder matrices indicated, by the network node, for the respective sub-band. The apparatus may be configured with a codebook comprising the set of precoder matrices configured the sub-band of the plurality of sub-bands. The means may be further configured for causing the apparatus to perform: receiving, from the network node, an indication of the set of precoder matrices for the sub-band of the plurality of sub-bands. The means configured for causing the apparatus to perform determining the rank indicator and the at least one precoder matrix may comprise means for causing the apparatus to perform: determining, for respective rank indicators of a plurality of rank indicators with respect to the plurality of sub-bands, a spectral efficiency, based, at least partially, on the estimated uplink channel, across the plurality of sub-bands provided using respective ordered sets of sub-band precoder matrices comprised in one of: the plurality of configured ordered sets of sub-band precoder matrices, or the plurality of ordered sets of sub-band precoder matrices indicated by the network node; determining the rank indicator, of the plurality of rank indicators, with a highest estimated spectral efficiency across the plurality of sub-bands; and determining, using the determined rank indicator with the highest estimated spectral efficiency across the plurality of sub-bands, the ordered set of sub-band precoder matrices. The means configured for causing the apparatus to perform determining the rank indicator and the at least one precoder matrix may comprise means for causing the apparatus to perform: receiving, from the network node, an indication of the rank indicator; and determining, for the rank indicator with respect to the plurality of sub-bands, an ordered set of sub-band precoder matrices estimated to provide a highest spectral efficiency based, at least partially, on the estimated uplink channel, wherein the ordered set of sub-band precoder matrices may be comprised in one of: the plurality of configured ordered sets of sub-band precoder matrices, or the plurality of ordered sets of sub-band precoder matrices indicated by the network node. The apparatus may be configured with a codebook comprising the plurality of configured ordered sets of sub-band precoder matrices. The means may be further configured for causing the apparatus to perform: receiving, from the network node, an indication of the plurality of ordered sets of sub-band precoder matrices. The uplink channel may be estimated based on a transpose of a downlink channel matrix representing the estimated downlink channel.

In accordance with one example embodiment, a (non-transitory) computer-readable medium comprising instructions stored thereon which, when executed with at least one processor, cause the at least one processor to: cause receiving, with a user equipment from a network node, of at least one channel state information reference signal; estimate a downlink channel based, at least partially, on the at least one channel state information reference signal; estimate an uplink channel based, at least partially, on the estimated downlink channel; determining a rank indicator and at least one precoder matrix based, at least partially, on the estimated uplink channel, wherein the at least one precoder matrix may comprise at least one of: a precoder matrix comprised in one of: a set of precoder matrices configured for a sub-band of a plurality of sub-bands configured for uplink transmission, or a set of precoder matrices indicated, by the network node, for the sub-band of the plurality of sub-bands, or an ordered set of sub-band precoder matrices comprised in one of: a plurality of configured ordered sets of sub-band precoder matrices, or a plurality of ordered sets of sub-band precoder matrices indicated by the network node; and cause transmitting, to the network node using the plurality of sub-bands, of at least one uplink transmission based, at least partially, on the determined rank indicator and the at least one determined precoder matrix.

In accordance with one example embodiment, a (non-transitory) computer-readable medium comprising instructions stored thereon for performing at least the following: causing receiving, with a user equipment from a network node, of at least one channel state information reference signal; estimating a downlink channel based, at least partially, on the at least one channel state information reference signal; estimating an uplink channel based, at least partially, on the estimated downlink channel; determining a rank indicator and at least one precoder matrix based, at least partially, on the estimated uplink channel, wherein the at least one precoder matrix may comprise at least one of: a precoder matrix comprised in one of: a set of precoder matrices configured for a sub-band of a plurality of sub-bands configured for uplink transmission, or a set of precoder matrices indicated, by the network node, for the sub-band of the plurality of sub-bands, or an ordered set of sub-band precoder matrices comprised in one of: a plurality of configured ordered sets of sub-band precoder matrices, or a plurality of ordered sets of sub-band precoder matrices indicated by the network node; and causing transmitting, to the network node using the plurality of sub-bands, of at least one uplink transmission based, at least partially, on the determined rank indicator and the at least one determined precoder matrix.

The example computer-readable medium may further comprise instructions stored thereon for performing: causing transmitting, to the network node, of an indication of the determined rank indicator. Instructions stored thereon for performing determining the rank indicator and the at least one precoder matrix may comprise instructions stored thereon for performing: determining, for respective rank indicators of a plurality of rank indicators with respect to respective sub-bands of the plurality of sub-bands, a precoder matrix estimated to provide a highest spectral efficiency based, at least partially, on the estimated uplink channel, wherein the precoder matrix may be comprised in one of: a set of precoder matrices configured for the respective sub-band, or a set of precoder matrices indicated, by the network node, for the respective sub-band; determining, for the respective rank indicators, an estimated spectral efficiency across the plurality of sub-bands produced using, for the respective sub-bands of the plurality of sub-bands, the precoder matrix estimated to provide the highest spectral efficiency; determining the rank indicator, of the plurality of rank indicators, with a highest estimated spectral efficiency across the plurality of sub-bands; and determining, using the determined rank indicator with the highest estimated spectral efficiency across the plurality of sub-bands, a respective precoder matrix for the respective sub-bands of the plurality of sub-bands. Instructions stored thereon for performing determining the rank indicator and the at least one precoder matrix may comprise instructions stored thereon for performing: causing receiving, from the network node, of an indication of the rank indicator; and determining, for the rank indicator with respect to respective sub-bands of the plurality of sub-bands, a precoder matrix estimated to provide a highest spectral efficiency based, at least partially, on the estimated uplink channel, wherein the precoder matrix may be comprised in one of: the set of precoder matrices configured for the respective sub-band, or the set of precoder matrices indicated, by the network node, for the respective sub-band. The user equipment may be configured with a codebook comprising the set of precoder matrices configured the sub-band of the plurality of sub-bands. The example computer-readable medium may further comprise instructions stored thereon for performing: receiving, from the network node, an indication of the set of precoder matrices for the sub-band of the plurality of sub-bands. Instructions stored thereon for performing determining the rank indicator and the at least one precoder matrix may comprise instructions stored thereon for performing: determining, for respective rank indicators of a plurality of rank indicators with respect to the plurality of sub-bands, a spectral efficiency, based, at least partially, on the estimated uplink channel, across the plurality of sub-bands provided using respective ordered sets of sub-band precoder matrices comprised in one of: the plurality of configured ordered sets of sub-band precoder matrices, or the plurality of ordered sets of sub-band precoder matrices indicated by the network node; determining the rank indicator, of the plurality of rank indicators, with a highest estimated spectral efficiency across the plurality of sub-bands; and determining, using the determined rank indicator with the highest estimated spectral efficiency across the plurality of sub-bands, the ordered set of sub-band precoder matrices. Instructions stored thereon for performing determining the rank indicator and the at least one precoder matrix may comprise instructions stored thereon for performing: causing receiving, from the network node, of an indication of the rank indicator; and determining, for the rank indicator with respect to the plurality of sub-bands, an ordered set of sub-band precoder matrices estimated to provide a highest spectral efficiency based, at least partially, on the estimated uplink channel, wherein the ordered set of sub-band precoder matrices may be comprised in one of: the plurality of configured ordered sets of sub-band precoder matrices, or the plurality of ordered sets of sub-band precoder matrices indicated by the network node. The user equipment may be configured with a codebook comprising the plurality of configured ordered sets of sub-band precoder matrices. The example computer-readable medium may further comprise instructions stored thereon for performing: causing receiving, from the network node, of an indication of the plurality of ordered sets of sub-band precoder matrices. The uplink channel may be estimated based on a transpose of a downlink channel matrix representing the estimated downlink channel.

In accordance with one example embodiment, a (non-transitory) program storage device readable by a machine may be provided, tangibly embodying instructions executable by the machine for performing operations, the operations comprising: causing receiving, with a user equipment from a network node, of at least one channel state information reference signal; estimating a downlink channel based, at least partially, on the at least one channel state information reference signal; estimating an uplink channel based, at least partially, on the estimated downlink channel; determining a rank indicator and at least one precoder matrix based, at least partially, on the estimated uplink channel, wherein the at least one precoder matrix may comprise at least one of: a precoder matrix comprised in one of: a set of precoder matrices configured for a sub-band of a plurality of sub-bands configured for uplink transmission, or a set of precoder matrices indicated, by the network node, for the sub-band of the plurality of sub-bands, or an ordered set of sub-band precoder matrices comprised in one of: a plurality of configured ordered sets of sub-band precoder matrices, or a plurality of ordered sets of sub-band precoder matrices indicated by the network node; and causing transmitting, to the network node using the plurality of sub-bands, of at least one uplink transmission based, at least partially, on the determined rank indicator and the at least one determined precoder matrix.

In accordance with one example embodiment, a (non-transitory) computer-readable medium comprising instructions that, when executed by an apparatus, cause the apparatus to perform at least the following: causing receiving, with a user equipment from a network node, of at least one channel state information reference signal; estimating a downlink channel based, at least partially, on the at least one channel state information reference signal; estimating an uplink channel based, at least partially, on the estimated downlink channel; determining a rank indicator and at least one precoder matrix based, at least partially, on the estimated uplink channel, wherein the at least one precoder matrix may comprise at least one of: a precoder matrix comprised in one of: a set of precoder matrices configured for a sub-band of a plurality of sub-bands configured for uplink transmission, or a set of precoder matrices indicated, by the network node, for the sub-band of the plurality of sub-bands, or an ordered set of sub-band precoder matrices comprised in one of: a plurality of configured ordered sets of sub-band precoder matrices, or a plurality of ordered sets of sub-band precoder matrices indicated by the network node; and causing transmitting, to the network node using the plurality of sub-bands, of at least one uplink transmission based, at least partially, on the determined rank indicator and the at least one determined precoder matrix.

In accordance with one example embodiment, a computer implemented system comprising: at least one processor and at least one (non-transitory) memory storing instructions that, when executed by the at least one processor, cause the system at least to perform: causing receiving, with a user equipment from a network node, of at least one channel state information reference signal; estimating a downlink channel based, at least partially, on the at least one channel state information reference signal; estimating an uplink channel based, at least partially, on the estimated downlink channel; determining a rank indicator and at least one precoder matrix based, at least partially, on the estimated uplink channel, wherein the at least one precoder matrix may comprise at least one of: a precoder matrix comprised in one of: a set of precoder matrices configured for a sub-band of a plurality of sub-bands configured for uplink transmission, or a set of precoder matrices indicated, by the network node, for the sub-band of the plurality of sub-bands, or an ordered set of sub-band precoder matrices comprised in one of: a plurality of configured ordered sets of sub-band precoder matrices, or a plurality of ordered sets of sub-band precoder matrices indicated by the network node; and causing transmitting, to the network node using the plurality of sub-bands, of at least one uplink transmission based, at least partially, on the determined rank indicator and the at least one determined precoder matrix.

In accordance with one example embodiment, a computer implemented system comprising: means for causing receiving, with a user equipment from a network node, of at least one channel state information reference signal; means for estimating a downlink channel based, at least partially, on the at least one channel state information reference signal; means for estimating an uplink channel based, at least partially, on the estimated downlink channel; means for determining a rank indicator and at least one precoder matrix based, at least partially, on the estimated uplink channel, wherein the at least one precoder matrix may comprise at least one of: a precoder matrix comprised in one of: a set of precoder matrices configured for a sub-band of a plurality of sub-bands configured for uplink transmission, or a set of precoder matrices indicated, by the network node, for the sub-band of the plurality of sub-bands, or an ordered set of sub-band precoder matrices comprised in one of: a plurality of configured ordered sets of sub-band precoder matrices, or a plurality of ordered sets of sub-band precoder matrices indicated by the network node; and means for causing transmitting, to the network node using the plurality of sub-bands, of at least one uplink transmission based, at least partially, on the determined rank indicator and the at least one determined precoder matrix.

The term “non-transitory,” as used herein, is a limitation of the medium itself (i.e. tangible, not a signal) as opposed to a limitation on data storage persistency (e.g., RAM vs. ROM).

As used herein, the terms “the at least one” and “the one or more” include “any one of the at least one” and “any one of the one or more”, respectively.

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modification and variances which fall within the scope of the appended claims.

1. An apparatus comprising:
at least one processor; and
at least one memory storing instructions that, when executed with the at least one processor, cause the apparatus at least to:
receive, from a network node, at least one channel state information reference signal;
estimate a downlink channel based, at least partially, on the at least one channel state information reference signal;
estimate an uplink channel based, at least partially, on the estimated downlink channel;
determine a rank indicator and at least one precoder matrix based, at least partially, on the estimated uplink channel, wherein the at least one precoder matrix comprises at least one of:
a precoder matrix comprised in one of:
a set of precoder matrices configured for a sub-band of a plurality of sub-bands configured for uplink transmission, or
a set of precoder matrices indicated, by the network node, for the sub-band of the plurality of sub-bands, or
an ordered set of sub-band precoder matrices comprised in one of:
a plurality of configured ordered sets of sub-band precoder matrices, or
a plurality of ordered sets of sub-band precoder matrices £ indicated by the network node; and
transmit, to the network node using the plurality of sub-bands, at least one uplink transmission based, at least partially, on the determined rank indicator and the at least one determined precoder matrix.

2. The apparatus of claim 1, wherein the instructions, when executed with the at least one processor, cause the apparatus to:
transmit, to the network node, an indication of the determined rank indicator.

3. The apparatus of claim 1, wherein determining the rank indicator and the at least one precoder matrix comprises the instructions, when executed with the at least one processor, cause the apparatus to:
determine, for respective rank indicators of a plurality of rank indicators with respect to respective sub-bands of the plurality of sub-bands, a precoder matrix estimated to provide a highest spectral efficiency based, at least partially, on the estimated uplink channel, wherein the precoder matrix is comprised in one of:
a set of precoder matrices configured for the respective sub-band, or
a set of precoder matrices indicated, by the network node, for the respective sub-band;
determine, for the respective rank indicators, an estimated spectral efficiency across the plurality of sub-bands produced using, for the respective sub-bands of the plurality of sub-bands, the precoder matrix estimated to provide the highest spectral efficiency;
determine the rank indicator, of the plurality of rank indicators, with a highest estimated spectral efficiency across the plurality of sub-bands; and
determine, using the determined rank indicator with the highest estimated spectral efficiency across the plurality of sub-bands, a respective precoder matrix for the respective sub-bands of the plurality of sub-bands.

4. The apparatus of claim 1, wherein determining the rank indicator and the at least one precoder matrix comprises the instructions, when executed with the at least one processor, cause the apparatus to:
receive, from the network node, an indication of the rank indicator; and
determine, for the rank indicator with respect to respective sub-bands of the plurality of sub-bands, a precoder matrix estimated to provide a highest spectral efficiency based, at least partially, on the estimated uplink channel, wherein the precoder matrix is comprised in one of:
the set of precoder matrices configured for the respective sub-band, or
the set of precoder matrices indicated, by the network node, for the respective sub-band.

5. The apparatus of claim 3, wherein the apparatus is configured with a codebook comprising the set of precoder matrices configured the sub-band of the plurality of sub-bands.

6. The apparatus of claim 3, wherein the instructions, when executed with the at least one processor, cause the apparatus to:
receive, from the network node, an indication of the set of precoder matrices for the sub-band of the plurality of sub-bands.

7. The apparatus of claim 1, wherein determining the rank indicator and the at least one precoder matrix comprises the instructions, when executed with the at least one processor, cause the apparatus to:
determine, for respective rank indicators of a plurality of rank indicators with respect to the plurality of sub-bands, a spectral efficiency, based, at least partially, on the estimated uplink channel, across the plurality of sub-bands provided using respective ordered sets of sub-band precoder matrices comprised in one of:
the plurality of configured ordered sets of sub-band precoder matrices, or
the plurality of ordered sets of sub-band precoder matrices indicated by the network node;
determine the rank indicator, of the plurality of rank indicators, with a highest estimated spectral efficiency across the plurality of sub-bands; and
determine, using the determined rank indicator with the highest estimated spectral efficiency across the plurality of sub-bands, the ordered set of sub-band precoder matrices.

8. The apparatus of claim 1, wherein determining the rank indicator and the at least one precoder matrix comprises the instructions, when executed with the at least one processor, cause the apparatus to:
receive, from the network node, an indication of the rank indicator; and
determine, for the rank indicator with respect to the plurality of sub-bands, an ordered set of sub-band precoder matrices estimated to provide a highest spectral efficiency based, at least partially, on the estimated uplink channel, wherein the ordered set of sub-band precoder matrices is comprised in one of:
the plurality of configured ordered sets of sub-band precoder matrices, or
the plurality of ordered sets of sub-band precoder matrices indicated by the network node.

9. The apparatus of claim 7, wherein the apparatus is configured with a codebook comprising the plurality of configured ordered sets of sub-band precoder matrices.

10. The apparatus of claim 7, wherein the instructions, when executed with the at least one processor, cause the apparatus to:
receive, from the network node, an indication of the plurality of ordered sets of sub-band precoder matrices.

11. The apparatus of claim 1, wherein the uplink channel is estimated based on a transpose of a downlink channel matrix representing the estimated downlink channel.

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. non-transitory computer-readable medium comprising instructions stored thereon for performing at least the following:
causing receiving, with a user equipment from a network node, of at least one channel state information reference signal;
estimating a downlink channel based, at least partially, on the at least one channel state information reference signal;
estimating an uplink channel based, at least partially, on the estimated downlink channel;
determining a rank indicator and at least one precoder matrix based, at least partially, on the estimated uplink channel, wherein the at least one precoder matrix comprises at least one of:
a precoder matrix comprised in one of:
a set of precoder matrices configured for a sub-band of a plurality of sub-bands configured for uplink transmission, or
a set of precoder matrices indicated, by the network node, for the sub-band of the plurality of sub-bands, or
an ordered set of sub-band precoder matrices comprised in one of:
a plurality of configured ordered sets of sub-band precoder matrices, or
a plurality of ordered sets of sub-band precoder matrices indicated by the network node; and
causing transmitting, to the network node using the plurality of sub-bands, of at least one uplink transmission based, at least partially, on the determined rank indicator and the at least £ one determined precoder matrix.

35. The computer-readable medium of claim 34, further comprising instructions stored thereon for performing:
causing transmitting, to the network node, of an indication of the determined rank indicator.

36. The computer-readable medium of claim 34, wherein instructions stored thereon for performing determining the rank indicator and the at least one precoder matrix comprises instructions stored thereon for performing:
determining, for respective rank indicators of a plurality of rank indicators with respect to respective sub-bands of the plurality of sub-bands, a precoder matrix estimated to provide a highest spectral efficiency based, at least partially, on the estimated uplink channel, wherein the precoder matrix is comprised in one of:
a set of precoder matrices configured for the respective sub-band, or
a set of precoder matrices indicated, by the network node, for the respective sub-band;
determining, for the respective rank indicators, an estimated spectral efficiency across the plurality of sub-bands produced using, for the respective sub-bands of the plurality of sub-bands, the precoder matrix estimated to provide the highest spectral efficiency;
determining the rank indicator, of the plurality of rank indicators, with a highest estimated spectral efficiency across the plurality of sub-bands; and
determining, using the determined rank indicator with the highest estimated spectral efficiency across the plurality of sub-bands, a respective precoder matrix for the respective sub-bands of the plurality of sub-bands.

37. The computer-readable medium of claim 34, wherein instructions stored thereon for performing determining the rank indicator and the at least one precoder matrix comprises instructions stored thereon for performing:
causing receiving, from the network node, of an indication of the rank indicator; and
determining, for the rank indicator with respect to respective sub-bands of the plurality of sub-bands, a precoder matrix estimated to provide a highest spectral efficiency based, at least partially, on the estimated uplink channel, wherein the precoder matrix is comprised in one of:
the set of precoder matrices configured for the respective sub-band, or
the set of precoder matrices indicated, by the network node, for the respective sub-band.

38. (canceled)

39. (canceled)

40. The computer-readable medium of claim 34, wherein instructions stored thereon for performing determining the rank indicator and the at least one precoder matrix comprises instructions stored thereon for performing:
determining, for respective rank indicators of a plurality of rank indicators with respect to the plurality of sub-bands, a spectral efficiency, based, at least partially, on the estimated uplink channel, across the plurality of sub-bands provided using respective ordered sets of sub-band precoder matrices comprised in one of:
the plurality of configured ordered sets of sub-band precoder matrices, or
the plurality of ordered sets of sub-band precoder matrices indicated by the network node;
determining the rank indicator, of the plurality of rank indicators, with a highest estimated spectral efficiency across the plurality of sub-bands; and
determining, using the determined rank indicator with the highest estimated spectral efficiency across the plurality of sub-bands, the ordered set of sub-band precoder matrices.

41. The computer-readable medium of claim 34, wherein instructions stored thereon for performing determining the rank indicator and the at least one precoder matrix comprises instructions stored thereon for performing:
causing receiving, from the network node, of an indication of the rank indicator; and
determining, for the rank indicator with respect to the plurality of sub-bands, an ordered set of sub-band precoder matrices estimated to provide a highest spectral efficiency based, at least partially, on the estimated uplink channel, wherein the ordered set of sub-band precoder matrices is comprised in one of:
the plurality of configured ordered sets of sub-band precoder matrices, or
the plurality of ordered sets of sub-band precoder matrices indicated by the network node.

42. (canceled)

43. The computer-readable medium of claim 40, further comprising instructions stored thereon for performing:
causing receiving, from the network node, of an indication of the plurality of ordered sets of sub-band precoder matrices.

44. The computer-readable medium of claim 34, wherein the uplink channel is estimated based on a transpose of a downlink channel matrix representing the estimated downlink channel.

45. An apparatus comprising:
at least one processor; and
at least one memory storing instructions that, when executed with the at least one processor, cause the apparatus at least to:
determine, for a respective sub-band of a plurality of sub-bands configured for uplink transmission with a user equipment, a precoder matrix from a set of precoder matrices that is configured for the respective sub-band; and
transmit, to the user equipment, an indication of the determined precoder matrix for the respective sub-band.
